(19) United States
(12) Patent Application Publication
(10) Pub. No.: US 2013/0204842 A1
(43) Pub. Date: Aug. 8, 2013

(54) METHOD AND SYSTEM FOR SYNCHRONIZATION OF DATA EDITED IN PARALLEL

(71) Applicant: Kunio Kamimura, TOKYO (JP)

(72) Inventor: Kunio Kamimura, TOKYO (JP)

(21) Appl. No.: 13/802,740

(22) Filed: Mar. 14, 2013

Related U.S. Application Data
(63) Continuation-in-part of application No. 13/714,422, filed on Dec. 14, 2012.
Application No. 13/714,422 is a continuation-in-part of application No. 13/024,330, filed on Feb. 10, 2011.
Application No. 13/024,330 is a continuation-in-part of application No. 12/864,872, filed on Nov. 18, 2010.
Application No. 13/714,422 is a continuation-in-part of application No. 13/251,295, filed on Oct. 3, 2011, now abandoned.
Application No. 13/251,295 is a continuation-in-part of application No. 12/688,854, filed on Jan. 15, 2010, now Pat. No. 8,171,003.
Application No. 12/688,854 is a continuation-in-part of application No. 12/601,005, filed on Apr. 13, 2010, now abandoned.
Application No. 13/251,295 is a continuation-in-part of application No. 12/864,872, filed on Nov. 18, 2010.
Application No. 13/714,422 is a continuation-in-part of application No. 12/743,367, filed on Oct. 12, 2010.
Application No. 13/714,422 is a continuation-in-part of application No. 12/995,158, filed on Nov. 29, 2010.
Application No. 13/714,422 is a continuation-in-part of application No. 12/601,005, filed on Apr. 13, 2010, now abandoned.
Application No. 13/714,422 is a continuation-in-part of application No. 12/864,872, filed on Nov. 18, 2010.

(30) Foreign Application Priority Data
Jun. 6, 2007 (JP) JP2007-150665
Jun. 12, 2008 (JP) PCT/JP2008/001506
Jul. 1, 2008 (JP) PCT/JP2008/001719

(51) Int. Cl. G06F 17/30

(52) U.S. Cl. CPC G06F 17/30356
USPC 707/638

(57) ABSTRACT

Fundamental methods, memory systems and processors systems to synchronize replicas of data by exchanging editing plans to replicas are first explained in Section 1. Other sections show derived methods and systems. Major derived methods and systems are expressed as independent claims. Section 2 shows synchronization supported by server providing relay function. Updating of replica is performed, using editing plans arranged in a sequence determined by the server. Section 3 shows synchronization supported by server providing ordinal numbers. Updating of replica is performed, using editing plans arranged in a sequence of ordinal numbers provided by the server. Section shows synchronization keeping reference consistency. Section 5 shows synchronization of edited data and edited definition of data. Even if definition of data is edited, replicas can synchronize each other. Section 6 shows synchronization by version control, which removes editing plans with old version before updating of replicas.

### BACKGROUND OF THE INVENTION

A replica of data can be kept by apparatuses equivalent to computers, such as personal computer, smart phone, tablet PC, game machines, and hardware controlled by programs. When replicas of such apparatuses are edited in parallel, required is synchronization of them.

### SUMMARY OF THE INVENTION

Though a word “data” 0150 is used in various context, the original meaning of data may be an abstract concept. When data has been recorded to a memory device 0104, data 0150 can be manipulated by processes 0105 or procedures 0107, 0110 which run on hardware 0106 handling the memory device 0104. Wherein, the hardware 0106 is equivalent to a processor, such as CPU of a computer, microprocessor, wired logic component, and so on.

Usually we use phrases “a memory device has data”, “data have been recoded on a memory device”. These phrases mean the followings. The memory device 0104 has a replica 0101 of the data 0150. A replica 0101 of the data 0150 is recorded on the memory device 0104.

Though data 0150 is abstract, the replica 0101 is expressed as concrete status of the memory device 0104. The memory device 0104 is a device of keeping a replica 0101 of data 0150. Examples of the memory devices 0104 are main memory (of a computer), HDD (hard disc drive), discs and devices having a capability of keeping a (replica of) data, which can be read and/or be written (or be updated) by hardware.

The hardware equivalent to processors 0106, which is called processor device, can implement processes 0105 or procedures of various functions including a function handling replica 0102 recorded on memory devices 0104. Examples of the processor device are processor unit of a computer, processor embedded in a hardware, wired logic constructed to implement a process or procedure, and equivalent hardware. Some processor device simultaneously performs plural processes and plural procedures. Single process on an operating system can implement plural number of threads, each of which can implement plural number of procedures. Plural threads of plural processes of plural processor can implement procedures of the present invention, when each thread, process or processor can access the replica 0101 directly or indirectly by supports of other threads, processes or hardware.

The present invention is to synchronize replicas 0101, 0121 of data 0150, which have been recorded on memory devices 0104, 0124 and have been edited in parallel. Explained are (1) methods handling a replica on memory device, (2) systems comprising of memory devices which contain replicas, and (3) systems comprising of devices equivalent to processors handling replicas. The methods and a component of the systems contain plural procedures directly or contain a process containing plural procedures.

Size of data may be small size or very large size. However, any portion of data is also a data. If someone needs to synchronize a portion of a big data, he can treat the portion of data as a data of the present invention. The portion of data will be synchronized by the present invention.

When the procedure or the process is described by a computer program, the program is recorded on HDD (Hard Disc Drive), ROM (Read Only Memory), USB memory, FD (Floppy Disc), other recording discs, memory device of a computer or server system, other non-transitory medium, and other memory devices. Before performing the process or procedures, the program is loaded into the main memory. The program can be sent through communications lines and be loaded into the main memory, too. If the program is already loaded, there is no need to do the above process. Thus the procedure is invoked. Some hardware may invoke programs recorded on memory device directly.

### 1. Fundamental Method and Systems

Fundamental method and systems are described citing FIG. 1.

### 1.1 Fundamental Method

All methods of the present invention are derived from the following fundamental method. Fundamental method shown by FIG. 1 comprises of plural procedures described as follows.

A method, comprising:
(1) A first procedure to be performed by one of single or plural processor devices which can handle a first replica of a data, wherein

said first procedure 0107 is configured to make a first editing plan 0102 of said first replica 0101, and

said first replica is recorded on a first memory device,

[Note 0] FIG. 1 shows the first processor device 0106 which can handle the first replica 0101. If only this situation is assumed, the first phrase can be the following: “A first procedure to be performed by a device which can handle a first replica of data”.

However, there is a multi-processors system. The method can be implemented by procedures, which are performed by different processors. Thus, four procedures, (1)-(4), are expressed by the following: “A first/second/third/fourth procedure to be performed by one of single or plural processor devices”.

[Note 1] Of course, it is possible to implement plural procedures by a single thread of single process of single processor device. However, plural procedures can be implemented by plural threads of plural processed of plural processor devices, when they can access the first replica 0101.
[Note 2] Phrase “an editing plan of the replica” means “a plan to edit the replica”.
[Note 3] One way of making the plan 0102 is the following. Before making the plan 0102, copy of the replica 0102 is created. The replica 0102 is treated as original replica and does not be used for temporal editing work. Editing work to the copy is recorded in the plan 0102. Namely, the plan 0102 contains journals of the editing work. The replica 0101 will be updated at (4), which will be described later.

As second way, the plan 0102 can be made without performing actual editing work to the replica 0101. The plan 0102 is a pure plan. A person who creates this kind of plan probably has a copy of the replica 0101 in his brain, and makes the plan 0102 by editing the copy.

As third way, a note of requests of edit to the replica can be the plan 0102, without performing actual edit. When a failure occurs at updating of the replica 0101 by the plan 0102, 0123 same results will occur to other replica 0121 by using same sequence of plans if initial status of both replicas is identical. Probably, actions of updating the first replica 0101 and the second replica 0121 by the plan 0102 are cancelled (“Rollback”), and the plan 0102, 0123 is removed from the sequence 0114. Thus, replicas 0101, 0121 synchronize each other. Even if replicas 0101, 0121 are left as broken replicas, these replicas synchronize as broken state.

As fourth way, a journal of editing work to the replica 0101, which is the original, can be a plan 0102. Before the editing work for making the plan 0102, there might be a case, in which the replica 0102 should be updated by another plan 0123. It depends on the assigned sequence 0114 to plans. If so, the editing work of the plan 0102 should be cancelled, that is called “Rollback”. The sequence is described in (4).

[Note 4] The first editing plan 0102 and the second editing plan 0123 can be recorded in the first memory device 0104, the second memory device 0124 or other memory device. Necessary is that these memory devices can be accessed by the procedures of the method. Dotted line of the first memory device 0104 means this situation.
(2) A second procedure to be performed by one of said single or plural processor devices, wherein

said second procedure 0108 is configured to send said first editing plan 0102 to a second process 0125.

[Note 1] The phrase of “sending a plan to a process” means “sending the plan to a place the process can access”. If the process runs on an apparatus which is equivalent with a computer, the plan is sent to a main memory, a secondary memory, a recording medium or any recording media accessible by the process running on a processor of the apparatus.
(3) A third procedure to be performed by one of said single or plural processor devices, wherein

said third procedure 0109 is configured to receive a second editing plan 0114 of a second replica 0121 of said data 0150, from said second process 0125

[Note 1] The phrase of “receiving a plan from the process” means “receiving the plan from a place the process can access”.
[Note 2] The first replica 0102 and the second replica 0121 may be recorded on different memory device, or on same memory device.

The first replica 0102 and the second replica 0121 may be recorded on different memory device, or on same memory device. No matter what kind of composition was selected, the followings are required. Procedures performed by the first processor device(s) 0106 can access said first replica 0101, and said first editing plans 0102, and said second editing plan 0123 which has been received. It is possible to record the replica in a file server, which can be a first memory device 0104 of the method, if the processes or procedures are running on a computer connected to the file server by communication path. Plans are sent to the server, or the computer, or other memory device which can be accessed from the computer.

(4) A fourth procedure to be performed by one of said single or plural processor devices, wherein

said fourth procedure 0110 is configured to update said first replica 0101, using said first editing plan 0102 and said second editing plan 0123 in order of a sequence 0114 assigned to said first editing plan 0102 and said second editing plan 0123, and

said sequence 0114 is used by a fifth procedure 0130 to update said second replica 0121.

### 1.2 Fundamental Systems

Methods of the present invention can be expressed as systems comprising of memory devices or systems comprising of processor devices. Examples of the processor device are processor unit of a computer, processor embedded in a hardware, wired logic constructed to implement a process or procedure, and equivalent hardware. The system comprising of memory devices is called memory system. The system comprising of processor devices is called processors system.

### 1.2.1 Fundamental Memory System

All memory systems of the present invention are derived from the fundamental memory system, which comprises of the following two memory devices and is memory system representation of the fundamental method.

A system comprising:
A first memory device 0104 containing

a first replica 0101 of a data 0150 and

a first editing plan 0102 to said first replica 0101.

A second memory device 0124 containing

a second replica 0121 of said data 0150 and

a second editing plan 0123 to said second replica 0121.

### Further,

(Sending: SF) said first editing plan 0102 is sent to said second memory device,
(Sending: SS) said second editing plan 0122 is sent to said first memory device.

### Further,

contents of said first replica 0102 and said second replica 0121 are identical after the following two updating operations:
(Operation:OF) operation of updating said first replica 0101 by said first editing plan 0102 and said second editing plan 0123 in order of a sequence 0114 assigned to said first editing plan 0102 and said second editing plan 0123, and
(Operation: OS) operation of updating said second replica 0121 by said first editing plan 0102 and said second editing plan 0123 in order of said sequence 0114.
   [Note 1] Labels, (Sending: SF), (Sending: SS), (Operation: OF) and (Operation: OS), are used in the latter part of this specification, in order to simplify the explanation of the modifications to them. However, these labels are removed from the language of claims of the initial submission.

### 1.2.2 Fundamental Processors System

All processors systems of the present invention are derived from the fundamental processor system, which comprises of the following two processor devices and is processors system representation of the fundamental method.

A system comprising:
A first device 0106 which runs a first process 0105 containing:

a first procedure 0107 configured to make a first editing

plan 0102 of a first replica 0101 of a data 0150.

A second device 0126 which runs a second process 0125 containing:
a second procedure 0127 configured to make a second editing plan 0123 of a second replica 0121 of said data 0150.
   Said first process 0105 is further containing:
a third procedure 0108 configured to send said first editing plan 0102 to said second process 0125, a fourth procedure 0109 configured to receive said second editing plan 0123 from said second process 0125,
a fifth procedure 0107 configured to update said first replica 0101, using said first editing plan 0102 and said second editing plan 0123, in order of a sequence 0114 assigned to said first editing plan 0102 and said second editing plan 0123.
   Said second process 0125 is further containing:
a sixth procedure 0128 configured to send said second editing plan 0123 to said first process 0105,
a seventh procedure 0129 configured to receive said first editing plan 0102 from said first process 0105,
an eighth procedure 0130 configured to update said second replica 0121, using said first editing plan 0102 and said second editing plan 0123, in order of said sequence 0114.

### BRIEF DESCRIPTION OF THE DRAWINGS

FIG. 1 shows fundamental method and systems.

FIG. 2A shows concept of synchronization supported by server providing relay function.

FIG. 2B shows process of synchronization supported by server providing relay function.

FIG. 2C shows procedure of asking the apparatus for sending editing plan.

FIG. 3 shows ways to determine sequence.

FIG. 4A shows concept of synchronization supported by server providing relay ordinal numbers.

FIG. 4B shows process of synchronization supported by server providing relay ordinal numbers.

FIG. 5 shows synchronization keeping reference consistency.

FIG. 6A shows data structure containing definition and defined data.

FIG. 6B shows concept of synchronization of edited data and edited definition of data.

FIG. 7A shows progress of version number of replica and value of version number assigned to editing plan.

FIG. 7B shows validity of editing plan by checking by checking value of version number assigned to editing plan.

FIG. 7C shows process of synchronization by version control.

FIG. 8 shows simple example of changing reference by keeping reference consistency.

FIG. 9 shows another example of changing reference by keeping reference consistency.

FIG. 10 shows advanced example of changing reference by keeping reference consistency.

FIG. 11 shows an example of multiple changing references combined with version control.

FIG. 12 shows an example of transition of replica based on synchronization of edited data and edited definition of data.

FIG. 13 shows an example of changing of version of replica

FIG. 14 shows an example of competition control based on version control.

### DETAILED DESCRIPTION OF THE INVENTION

### 2. Synchronization Supported by Server Providing Relay Function

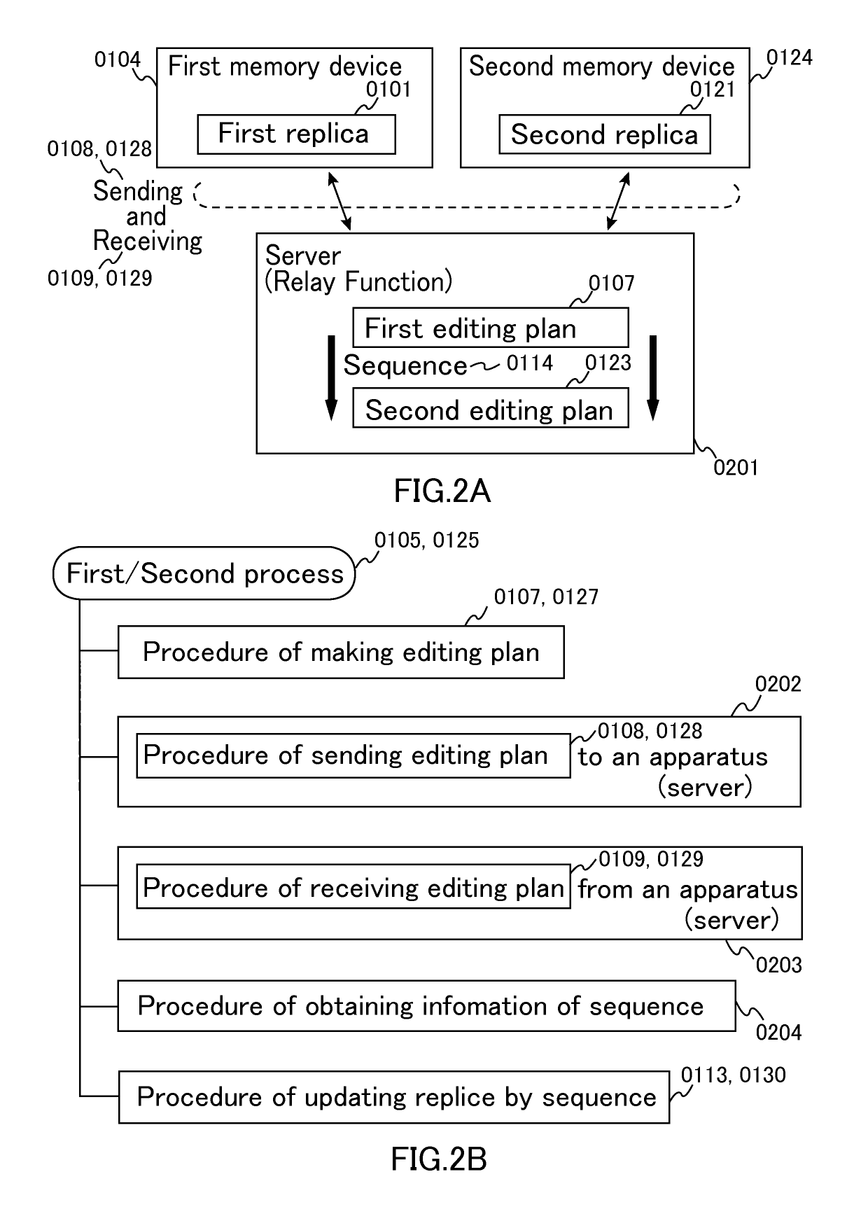

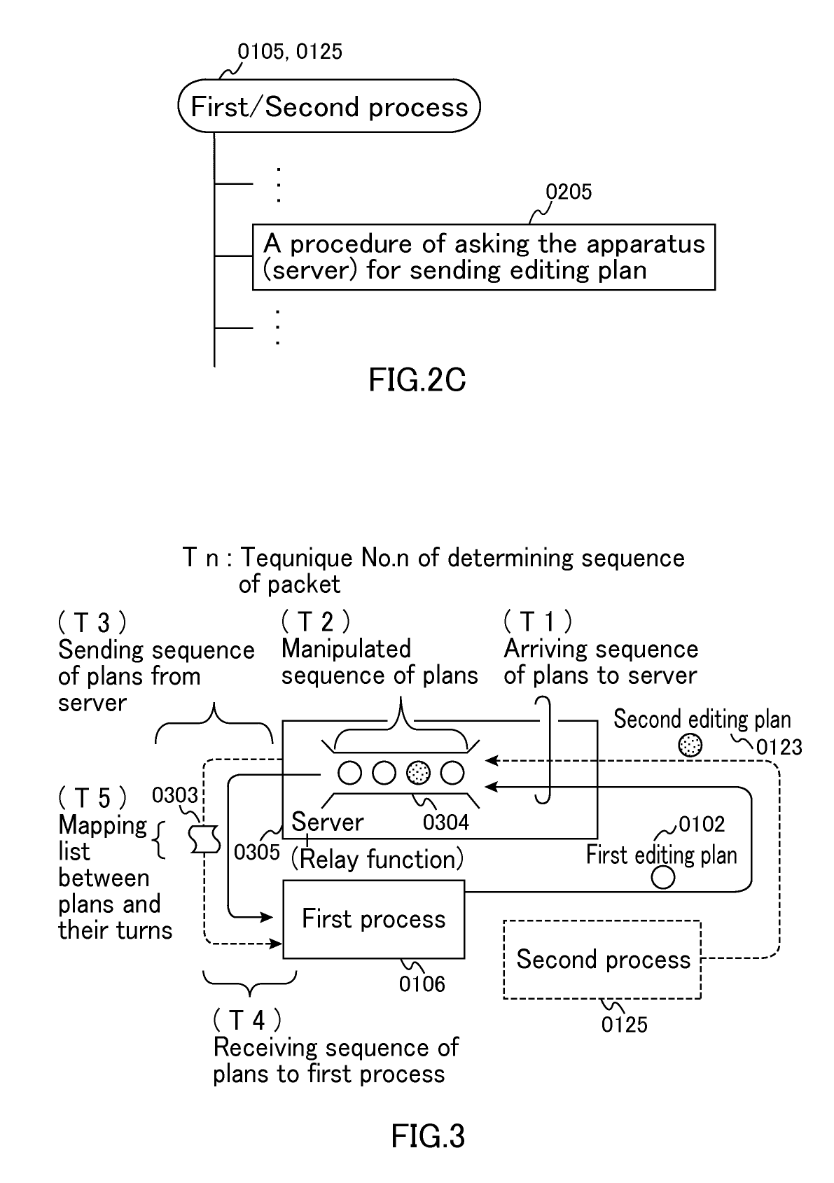

Fundamental synchronization described in Section 1 can be upgraded by introducing an apparatus providing a relay function of editing plans. The apparatus is named server 0201, in FIG. 2A.

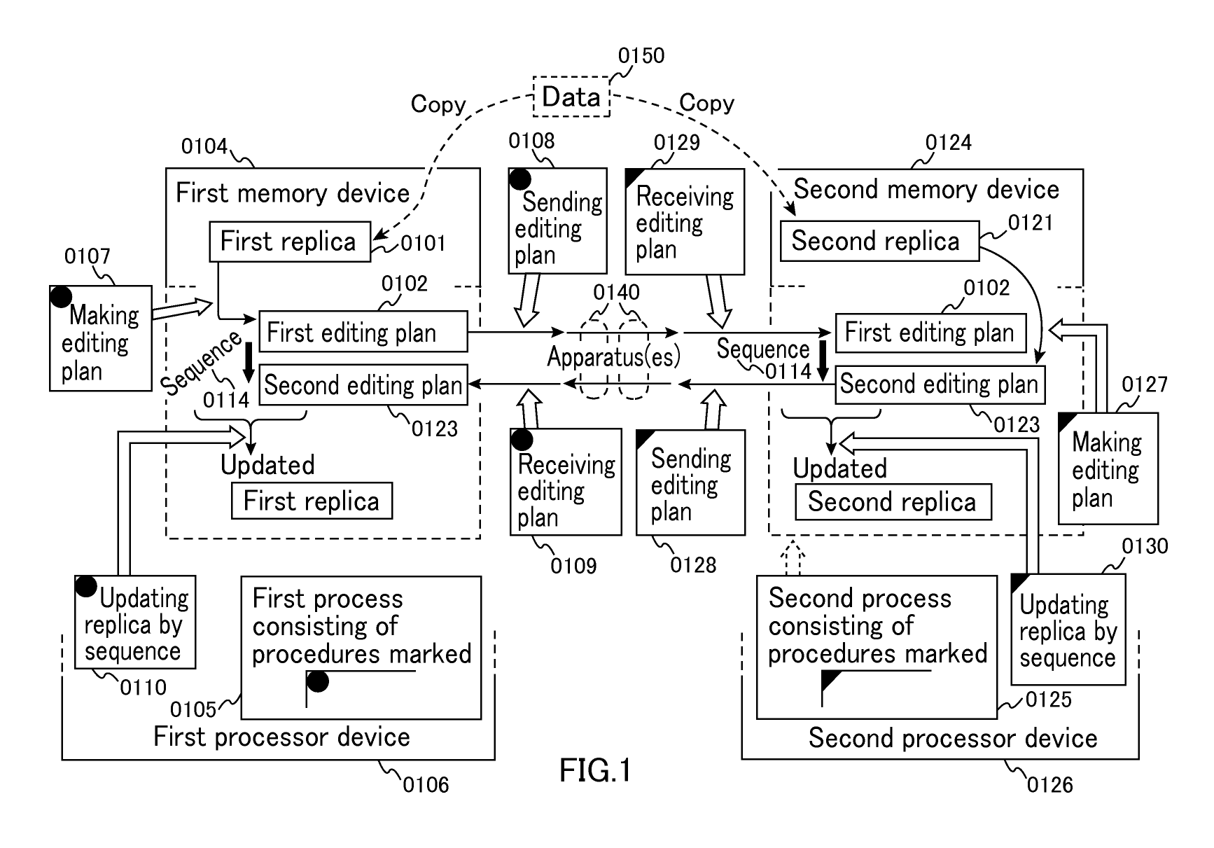

Method and systems, which are supported by the server, are described citing FIG. 1, FIG. 2A, FIG. 2B, FIG. 2C and FIG. 3.

### 2.1 Method of Synchronization Supported by Server Providing Relay Function

2.1.1 Method Expressed as Derived from the Fundamental

The fundamental method, wherein

said second procedure 0108, 0202 is configured to send said first editing plan 0102 to an apparatus 0201,
said third procedure 0109, 0203 is configured to receive a second editing plan 0123 of a second replica 0121 of said data 0150, from an apparatus 0201,
said fourth procedure 0110 is configured to update said first replica 0101, using said first editing plan 0102 and said second editing plan 0123 in order of a sequence 0114 determined by information from said apparatus 0201.

Namely, phrase of “to a second process 0125”, which is contained in the second procedure of the fundamental method, is replaced by phrase “to an apparatus 0201”. Phrase of “from said second process 0125”, which is contained in the third procedure of the fundamental method, is replaced by phrase “from an apparatus 0201”. The apparatus 0201 of FIG. 2 may be one of apparatuses 0140 in FIG. 1. The server 0305 of FIG. 3 can be the apparatus 0201.

Phrase of “a sequence 0114 assigned to said first editing plan 0102 and said second editing plan 0123”, which is contained in the forth procedure of the fundamental method, is replaced by phrase “a sequence 0114 determined by information from said apparatus 0201”.

[Note 1] The information and sequence is further discussed in Section 2.4.
[Note 2] The server 0201 is an apparatus implementing at least the functions described above, and not a server in meaning used in documents about internet or communications generally. Further, other servers in this specification are apparatuses implementing at least the functions described in each method or system.

### 2.1.2 Method Expressed as Independent

The derived method can be expressed as an independent method, which can be obtained by replacing phrases as shown in the previous section. This is the original claim 1 described in specification of the application 13714422, as follows.

A method, comprising:
a first procedure 0107 to be performed by one of single or plural processor devices 0106 which can handle a first replica 0101 of a data 0150, wherein
said first procedure 0107 is configured to make a first editing plan 0102 of said first replica 0101, and
said first replica 0101 is recorded on a first memory device 0104,
   a second procedure 0108 to be performed by one of said single or plural processor devices 0106, wherein
said second procedure 0108 is configured to send said first editing plan 0102 to an apparatus 0201, 0305, 0140,
   a third procedure 0109 to be performed by one of said single or plural processor devices 0106, wherein
said third procedure 0109 is configured to receive a second editing plan 0123 of a second replica 0121 of said data 0150, from said apparatus 0201, 0305, 0140,
   a fourth procedure 0110 to be performed by one of said single or plural processor devices 0106, wherein
said fourth procedure 0110 is configured to update said first replica 0101, using said first editing plan 0102 and said second editing plan 0123 in order of a sequence 0114 determined by information from said apparatus 0201, 0305, 0140, and
said sequence 0114 is used by a fifth procedure 0130 to update said second replica 0121.

### 2.2 Memory System of Synchronization Supported by Server Providing Relay Function

2.2.1 Memory System Expressed as Derived from the Fundamental

The fundamental memory system, wherein

(Sending: SF) said first editing plan 0102 is sent 0108 to said second memory device 0124 through an apparatus 0201, 0305, 0140,
(Sending: SS) said second editing plan 0123 is sent 0128 to said first memory device 0104 through said apparatus 0201, 0305, 0140,
(Operation: OF) said first replica 0102 is updated 0110 by said first editing plan 0102 and said second editing plan 0123 in order of a sequence 0114 determined by information provided by said apparatus 0201, 0305, 0140,

Namely, phrase “through said apparatus 0201, 0305, 0140” is added to (Sending: SF) and (Sending: SF).

Phrase “a sequence 0114 assigned to said first editing plan 0102 and said second editing plan 0123”, which is contained in (Operation: OF) of the fundamental method, is replaced by phrase “a sequence 0114 determined by information from said apparatus 0201”.
[Note 1] The information and sequence is further discussed in Section 2.4.
[Note 2] The phrase of “said sequence” in (Operation: OS) means the sequence expressed in the above (Operation: OF).

### 2.2.2 Memory System Expressed as Independent

The derived memory system can be expressed as an independent memory system, which can be obtained by replacing phrases as shown in the previous section. This is the original claim 4 described in specification of the application 13714422, as follows.

A system, comprising:
a first memory device 0104 containing
a first replica 0101 of a data and
a first editing plan 0102 to said first replica, and
   a second memory device 0124 containing
a second replica 0121 of said data and
a second editing plan 0123 to said second replica,
   further,
said first editing plan 0102 is sent to said second memory device 0124 through an apparatus 0201, 0305, 0140, said second editing plan 0123 is sent to said first memory device 004 through said apparatus 0201, 0305, 0140,
   further,
contents of said first replica 0101 and said second replica 0121 are identical after the following two updating operations:
   operation of updating said first replica 0101 by said first editing plan 0102 and said second editing plan 0123 in order of a sequence 0114 determined by information provided by said apparatus 0201, 0305, 0140, and
   operation of updating said second replica 0121 by said first editing plan 0102 and said second editing plan 0123 in order of said sequence 0114.

### 2.3 Processors System of Synchronization Supported by Server Providing Relay Function

2.3.1 Processor System Expressed as Derived from the Fundamental
The fundamental processor system, wherein
said third procedure 0108, 0202 is configured to send said first editing plan 0102 to an apparatus 0201, 0305, 0140, and said fourth procedure 0109, 0203 configured to receive said second editing plan 0123 from an apparatus 0201, 0305, 0140, said sixth procedure 0128, 0202 configured to send said second editing plan 0123 to said apparatus 0201, 0305, 0140,
said seventh procedure 0129, 0203 configured to receive said first editing plan 0102 from said apparatus 0201, 0305, 0140,
further,
said fifth procedure 0110 configured to update said first replica 0101, using said first editing plan 0102 and said second editing plan 0123, in order of a sequence 0114 determined by information from said apparatus 0201, 0305, 0140.

Namely, phrases “send/receive to/from first/second process”, which are contained in the fundamental method, are replaced by phrases “send/receive to/from first/second apparatus 0201, 0305, 0140”. Phrase of “a sequence 0114 assigned to said first editing plan 0102 and said second editing plan 0123”, which is contained in the fifth procedure of the fundamental method, is replaced by a phrase “a sequence 0114 determined by information from said apparatus 0201, 0305, 0140”.

[Note 1] The information and sequence is further discussed in Section 2.4.
[Note 2] The phrase of “said sequence” in the eighth procedure means the sequence expressed in the replaced fifth procedure.

### 2.3.2 Processor System Expressed as Independent

The derived processor system can be expressed as an independent processor system, which can be obtained by replacing procedures of the fundamental processors system as shown in the previous section. This is the original claim 7 described in specification of the application 13714422, as follows.

A system comprising:
a first device 0106 which runs a first process 0105 containing:

a first procedure 0107 configured to make a first editing

plan 0102 of a first replica 0101 of a data 0150, and a second device 0126 which runs a second process 0125 containing:
a second procedure 0127 configured to make a second editing plan 0123 of a second replica 0121 of said data 0150,
   said first process 0105 is further containing:
a third procedure 0108 configured to send said first editing plan 0102 to an apparatus 0201, 0305, 0140, and a fourth procedure 0109 configured to receive said second editing plan 0123 from said apparatus 0201, 0305, 0140, a fifth procedure 0110 configured to update said first replica 0101, using said first editing plan 0102 and said second editing plan 0123, in order of a sequence 0114 determined by information from said apparatus 0201, 0305, 0140,
   said second process 0125 is further containing:
a sixth procedure 0128 configured to send said second editing plan 0123 to said apparatus 0201, 0305, 0140, a seventh procedure 0129 configured to receive said first editing plan 0102 from said apparatus 0201, 0305, 0140, an eighth procedure 0130 configured to update said second replica 0121, using said first editing plan 0102 and said second editing plan 0123, in order of said sequence 0114.

### 2.4 Further Derived Methods and Systems

(1) The method of section 2.1.1 or 2.1.2, further comprising: a sixth procedure to be performed by one of said single or plural processor devices, wherein

said sixth procedure 0205 (FIG. 2C) configured to ask said apparatus 0201, 0305, 0140 for sending said second editing plan, before executing said third process.

(2) The processors system of Section 2.3.1 or 2.3.2, wherein said first process 0105 further contains
a ninth procedure 0205 configured to ask said apparatus 0201, 0305, 0140 for sending said second editing plan 0123 to said first process 0105, before executing said fourth process.
   said second process 0125 further contains
a tenth procedure 0205 configured to ask said apparatus 0201, 0305, 0140 for sending said first editing plan 0102 to said second process, before executing said seventh process.
   (3) The methods or systems of Sections 2.1, 2.2 and 2.3, where in
   (i) said sequence 0114 is an arriving sequence of said first editing plan 0102 and said second editing plan 0123 to the server 0201, 0305, 0140 or
   (ii) said sequence 0114 is a sequence which has been set to said first editing plan 0102 and said second editing plan 0123 on the server 0201, 0305, 0140 or
   (iii) said sequence 0114 is a sequence of ending said first editing plan 0127 and said second editing plan 0123 from the server 0201, 0305, 0140 or
   (iv) said sequence 0114 is a sequence of receiving said first editing plan 0102 and said second editing plan 0123 by said first process 0105 and said second process 0125.
   (v) said sequence 0114 is a sequence informed by a list 0303 showing sequence of plans.
   [Note 1] The (i) is shown (T1) of FIG. 3B. Plans are arriving from the first process 0101 and the second process 0105.
   The (ii) is shown (T2) of FIG. 3B. Sequence of plans in the queue 0304 may be manipulated. The (iii) is shown (T3) of FIG. 3B. Plans are sent from the server 0305. The (iv) is shown (T4) of FIG. 3 B. Plans are arriving to the first process 0101.
   The (v) is shown (T5) of FIG. 3 B. List 0303 showing sequence 0114 of plans are delivered to the first process 0101.
   (4) The (i) of T1 is expressed by the original claims 2, 5 and 8 of the initial submission accompanied with this specification. The (iii) of T3 is expressed by the original claims 3, 6 and 9 of the initial submission accompanied with this specification. However, these claims cover some parts of T2, T4 and T5, as described in Note 2.

### 3 Synchronization Supported by Server Providing Ordinal Numbers

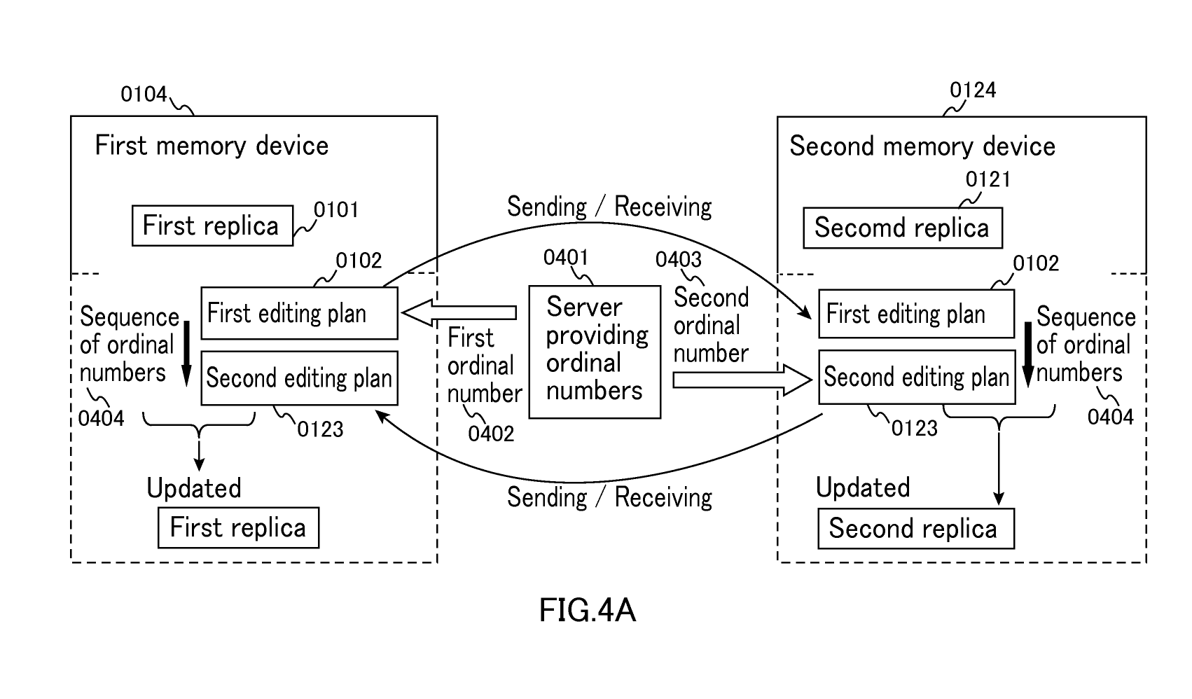

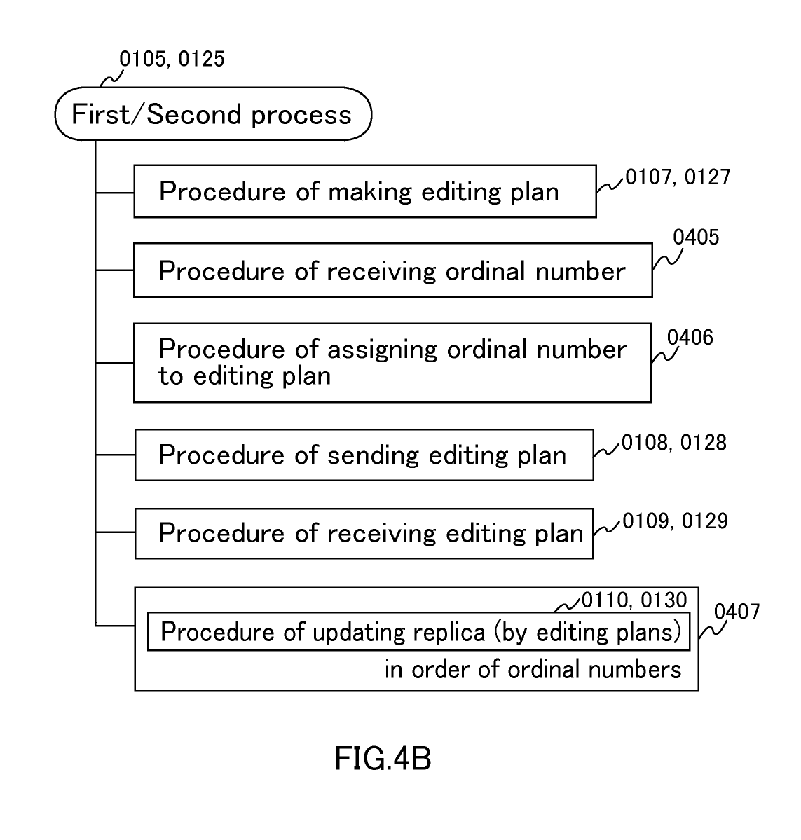

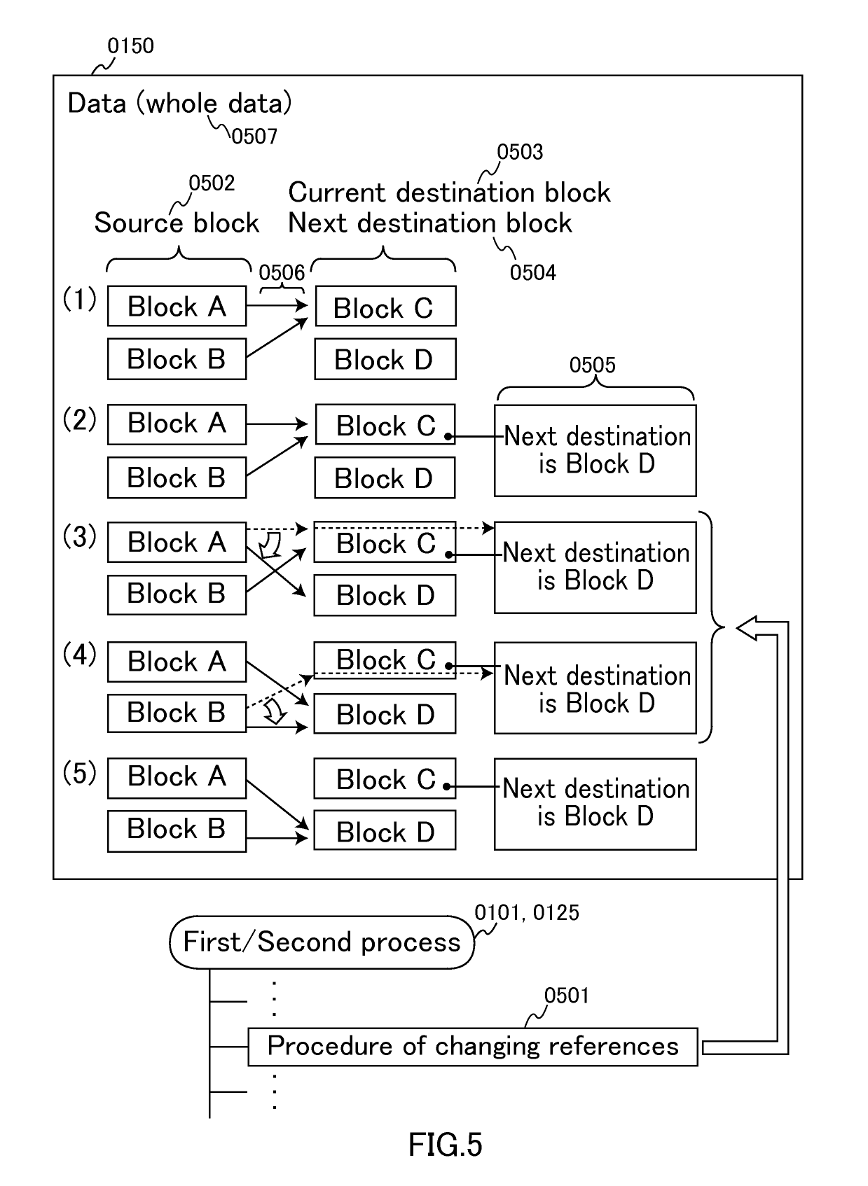

Method and systems, which are supported by a server providing ordinal numbers, are described citing FIG. 1, FIG. 4A and FIG. 4B.

### 3.1 Method of Synchronization Supported by Server Providing Ordinal Numbers

3.1.1 Method Expressed as Derived from the Fundamental
The fundamental method, wherein

procedure names (from “second” to “fifth”) of the fundamental method are renamed (from “forth” to “seventh”), in order to insert new procedures named second and third procedures,

a second procedure to be performed by one of said single or plural processor devices, wherein

said second procedure 0405 configured to receive a first ordinal number 0402 provided by an apparatus 0401,

a third procedure to be performed by one of said single or plural processor devices, wherein

said third procedure 0406 configured to assign said first ordinal number 0401 to said first editing plan 0101,
further,

said sixth procedure 0110, 0407 configured to update said first replica 0101, using said first editing plan 0102 and said second editing plan 0123 in order of a sequence 0114, 0404 determined by said first ordinal number 0402 and said second ordinal number 0403,

said order is used by a seventh procedure 0130, 0407 of said second process 0125 to update said second replica 0121.

### 3.1.2 Method Expressed as Independent

The derived method can be expressed as an independent method, which can be obtained as shown in the previous section. Namely,

(1) Procedures names of the fundamental method are renamed.
(2) New procedures, second and third procedures are inserted.
(3) the sixth procedure is replaced.

This is the original claim 10 described in specification of the application 13714422, as follows.

A method, comprising:
a first procedure 0107 to be performed by one of single or plural processor devices 0106 which can handle a first replica 0101 of a data 0150, wherein
said first procedure 0107 is configured to make a first editing plan 0102 of said first replica 0101, and said first replica 0101 is recorded on a first memory device 0104,
   a second procedure 0405 to be performed by one of said single or plural processor devices 0106, wherein
said second procedure 0405 configured to receive a first ordinal number 0402 provided by an apparatus 0401, 0140,
   a third procedure 0406 to be performed by one of said single or plural processor devices, wherein

said third procedure 0406 configured to assign said first

ordinal number 0402 to said first editing plan 0102, a fourth procedure to be performed by one of said single or plural processor devices, wherein

said fourth procedure 0108 is configured to send said

first editing plan 0102 to a second process 0125, a fifth procedure 0109 to be performed by one of said single or plural processor devices 0110, wherein

said fifth procedure 0109 is configured to receive a

second editing plan 0123 of a second replica 0121 of said

data 0150, from said second process 0125,

a sixth procedure 0110 to be performed by one of said single
or plural processor devices 0106, wherein
said sixth procedure 0110 configured to update said first replica 0101, using said first editing plan 0102 and said second editing plan 0123 in order of a sequence 0114, 0404 determined by said first ordinal number 0402 and said second ordinal number 0403,
said sequence 0114, 0404 is used by a seventh procedure 0130 of said second process 0125 to update said second replica 0121.

### 3.2 Memory System of Synchronization Supported by Server Providing Ordinal Numbers

3.2.1 Memory System Expressed as Derived from the Fundamental

The fundamental memory system, wherein

said first editing plan 0102 is assigned a first ordinal number 0402 provided by an apparatus 0401,
said second editing plan 0123 is assigned a second ordinal number 0403 provided by said apparatus 0401,
(Operation: OF) said first replica 0101 is updated 0407 by said first editing plan 0102 and said second editing plan 0123 in order of a sequence 0114, 0404 determined by said first ordinal number 0402 and said second ordinal number 0403,
[Note] The phrase of “said sequence” in (Operation: OS) means the sequence expressed in the above (Operation: OF).

### 3.2.2 Memory System Expressed as Independent

The derived memory system can be expressed as an independent memory system, which can be obtained

by adding the following sentences to descriptions of the first memory 0104 device and the second memory device 0124:

“said first editing plan is assigned a first ordinal number 0402 provided by an apparatus 0401”,
“said second editing plan is assigned a second ordinal number 0403 provided by said apparatus 0401”, and

by replacing (Operation: OF) of the fundamental memory system by (Operation: OF) of described in the previous section.

[Note] The phrase of “said sequence” in (Operation: OS) means the sequence expressed in the above (Operation: OF).

This is the original claim 11 described in specification of the application 13714422, as follows,

A system, comprising:
A first memory device 0104 containing
a first replica 0101 of a data 0150 and
a first editing plan 0102 to said first replica 0101, said first editing plan 0102 is assigned a first ordinal number 0402 provided by an apparatus 0401,
   a second memory device 0124 containing
a second replica 0121 of said data 0150 and
a second editing plan 0123 to said second replica 0121,
said second editing plan 0123 is assigned a second ordinal number 0403 provided by said apparatus 0401,
   further,
said first editing plan 0102 is sent to said second memory device 0124,
said second editing plan 0123 is sent to said first memory device 0104,
   further,
contents of said first replica 0101 and said second replica 0121 are identical after the following two updating operations:
   operation of updating said first replica 0101 by said first editing plan 0102 and said second editing plan 0123 in order of a sequence 0114, 0404 determined by said first ordinal number 0402 and said second ordinal number 0403, and
   operation of updating said second replica 0123 by said first editing plan 0102 and said second editing plan 0123 in order of said sequence 0114, 0404.

### 3.3 Processor System of Synchronization Supported by Server Providing Ordinal Numbers

3.3.1 Processors System Expressed as Derived from the Fundamental
The fundamental processor, wherein
in order to insert the following new second procedure and third procedure, second procedure renamed to fourth procedure,
a second procedure 0405 configured to receive a first ordinal number 0402 provided by an apparatus 0401.
a third procedure 0406 configured to assign said first ordinal number 0402 to said first editing plan 0102.

### Further,

in order to insert the following new fifth procedure and sixth procedure, procedures name (from “third” to “eighth”) of the fundamental method are renamed (from “seventh” to “twelfth”),
a fifth procedure 0405 configured to receive a second ordinal number 0403 provided by said apparatus 0401.
a sixth procedure 0406 configured to assign said second ordinal number 0403 to said second editing plan 0123.
   The renamed ninth (former fifth) procedure is replaced to:
a ninth procedure 0110, 0407 configured to update said first replica 0102, using said first editing plan 0102 and said second editing plan 0123 in order of a sequence 0114, 0402 determined by said first ordinal number 0402 and said second ordinal number 0403,
   [Note] The phrase of “said sequence” of twelfth procedure means the sequence expressed by the ninth procedure.

### 3.3.2 Processor Systems Expressed as Independent

The derived processor system can be expressed as an independent processor system, which can be obtained by renaming, inserting and replacing procedures as shown in the previous section. This is the original claim 12 described in specification of the application 13714422, as follows.

A system comprising:
a first device 0106 which runs a first process 0105 containing:
a first procedure 0107 configured to make a first editing plan 0102 of a first replica 0101 of a data 0150,
a second procedure 0405 configured to receive a first ordinal number 0402 provided by an apparatus 0401,
a third procedure 0406 configured to assign said first ordinal number 0402 to said first editing plan 0102,
   a second device 0126 which runs a second process 0125 containing:
a fourth procedure 0127 configured to make a second editing plan 0123 of a second replica 0121 of said data 0150,
a fifth procedure 0405 configured to receive a second ordinal number 0403 provided by said apparatus 0401,
a sixth procedure 0406 configured to assign said second ordinal number 0403 to said second editing plan 0123,
   said first process 0106 is further containing:
a seventh procedure 0108 configured to send said first editing plan 0102 to said second process 0125,
an eighth procedure 0109 configured to receive said second editing plan 0123 from said second process 0125,
a ninth procedure 0110 configured to update said first replica 0101, using said first editing plan 0102 and said second editing plan 0123, in order of a sequence 0114, 0404 determined by said first ordinal number 0402 and said second ordinal number 0403,
   said second process 0125 is further containing:
a tenth procedure 0128 configured to send said second editing plan 0123 to said first process 0105,
an eleventh procedure 0129 configured to receive said first editing plan 0102 from said first process 0105,
a twelfth procedure 0130 configured to update said second replica 0121, using said first editing plan 0102 and said second editing plan 0123, in order of said sequence 0114, 0404.

### 4. Synchronization Keeping Reference Consistency

Method and systems, which implement synchronization keeping reference consistency, are described citing FIG. 1 and FIG. 5.

FIG. 5 shows data that will be treated by the method keeping reference consistency. Class of Cis a data of defining a memory block of data (or “data block”). Structure of C and C++ is a data of defining a block of data. These blocks of data are handled by well-known computer programming languages such as C, C++, Pascal, LISP and so on.

Reference from a block to another block can be expressed by various ways. When these blocks are expressed on a memory device, a pointer, which is an address of the block, can show the reference. Reference represented by the pointer can be recorded to a secondary memory by ways shown in U.S. patent Ser. No. 09/117,669. When each block has identifier, an identifier of a destination block can be reference from source block.

The initial state is shown by (1) of FIG. 5, wherein the block A and the block B refer to the block C that is the current destination block. If someone intended to change all references to the block C into the block D, all things he has to do is to change references from the block A and the block B. If there are very many blocks referring the block C, this task will not be easy. If an editing plan contains this task, the editing plan will be very large.

In order to resolve this problem, the editing plan can be simplified to attach data indicating the next destination block (block D), to the current destination block (block C). The editing plan will be sent to other replicas. When a reference to the block C (the current destination block) is accessed at each replica, the reference in the first replica 0102 (or the second replica 0111) will be changed in order to refer the block D (the next destination block), as shown (3) and (4) of FIG. 5. The final state is shown by (5) of FIG. 5, wherein the block A and the block B refer to the block D that is the next destination block.

### 4.1 Method of Synchronization Keeping Reference Consistency

4.1.1 Method Expressed as Derived from the Fundamental
A method keeping reference consistency is the fundamental method, further
said whole data 0150, 0507 contains data expressing plural data blocks, which are
a first data block (source block 0502)
a second data block (current destination block 0503)
which is referenced 0506 from said first data block (source block 0502)
a third data block (next destination block 0504) which is to be referenced 0506 from said first data block (source data block 0502) in future
   further
said whole data contains a reference 0506, which is associated with said first data block (source block) 050 indicating said second block (current destination block) 0503
said second editing plan 0123 contains a data 0505 of changing reference indicating said third data block (next destination block) 0504,
   [Note 1] The data 0150 of the fundamental method is renamed as “whole data” 0507 for avoiding confusions, because it contains data expressing plural data blocks.
   [Note 2] The “a data of changing reference indicating said third data block (next destination block 0504)” is a data 0505 in FIG. 5 showing “Next destination is the block D” which is attached to the block C of (2).
   Further, the fundamental method comprising of
   a fifth procedure to be performed by one of said single or plural processor devices 0106, wherein

said fifth procedure 0501 configured to perform the following steps,

(Step 1) a step of accessing said first data block (source block) 0502 and said reference 0506,
(Step 2) a step of accessing said second data block (current destination block) 0503,
(Step 3) a step of accessing said data of changing said reference 0505, and
(Step 4) a step of changing said reference 0506 so as to indicate said third data block (next destination block) 0504, according to said data of changing reference 0505.

### 4.1.2 Method Expressed as Independent

The derived method can be expressed as an independent method, which can be obtained by replacing data 0150 of the first and third procedure to whole data 0507, by adding phrases shown in the previous section. This is the original claim 13 described in specification of the application 13714422. Further, this is the initial claim 1 of this application.

### 4.2 Memory System of Synchronization Keeping Reference Consistency

4.2.1 Memory System Expressed as Derived from the Fundamental

A memory system keeping reference consistency is the fundamental memory system, further

said whole data 0150, 0507 contains data expressing plural data blocks, which are
a first data block (source block 0502)
a second data block (current destination block 0503) which is referenced 0506 from said first data block (source block 0502)
a third data block (next destination block 0504) which is to be referenced 0506 from said first data block (source data block 0502) in future
   further
said whole data contains a reference 0506, which is associated with said first data block (source block) 050 indicating said second block (current destination block) 0503
said second editing plan 0123 contains a data 0505 of changing reference indicating said third data block (next destination block) 0504,
   further, said first replica 0102 and said second replica 0121 are changed by a procedure containing:
   (Step 1) a step of accessing said first data block (source block) 0502 and said reference 0506,
   (Step 2) a step of accessing said second data block (current destination block) 0503,
   (Step 3) a step of accessing said data of changing said reference 0505, and
   (Step 4) a step of changing said reference 0506 so as to indicate said third data block (next destination block) 0504, according to said data of changing reference 0505.

The note 1 and note 2 of Section 4.1.1 are also valid for the above claim.

### 4.2.2 Memory System Expressed as Independent

The derived memory system can be expressed as an independent memory system, which can be obtained by replacing data 0150 to whole data 0507, by adding phrases shown in the previous section.

This is the original claim 14 described in specification of the application 13714422, as follows.

A system, comprising:
A first memory device 0104 containing
a first replica 0101 of a whole data and
a first editing plan 0102 to said first replica 0101,
wherein
said whole data 0507, 150 contains data expressing plural data blocks, which are
a first data block (source block 0502)
a second data block (current destination block 0503) which is referenced 0506 from said first data block (source block 0502)
a third data block (next destination block 0504) which is to be referenced 0506 from said first data block (source data block 0502) in future
   further
said whole data contains a reference 0506, which is associated with said first data block (source block) 050 indicating said second block (current destination block) 0503
said second editing plan 0123 contains a data 0505 of changing reference indicating said third data block (next destination block) 0504,
   a second memory device 0124 containing
a second replica 0121 of said whole data 0507, 0150 and
a second editing plan 0123 to said second replica 0121,
   further,
said first editing plan 0102 is sent to said second memory device 0124,
said second editing plan 0102 is sent to said first memory device 0104,
   further,
contents of said first replica 0101 and said second replica 0121 are identical after the following two updating operations:
   operation of updating said first replica 0101 by said first editing plan 0102 and said second editing plan 0123 in order of a sequence 0114 assigned to said first editing plan 0102 and said second editing plan 0123,
   operation of updating said second replica 0121 by said first editing plan 0102 and said second editing plan 0123 in order of said sequence 0114,
      further,

said first replica 0101 is changed by a first procedure 0501 containing:

(Step 1) a step of accessing said first data block (source block) 0502 and said reference 0506,
(Step 2) a step of accessing said second data block (current destination block) 0503,
(Step 3) a step of accessing said data of changing said reference 0505, and
(Step 4) a step of changing said reference 0506 so as to indicate said third data block (next destination block) 0504, according to said data of changing reference 0505.

said second replica 0121 are changed by a second procedure 050 containing:

(Step 1) a step of accessing said first data block (source block) 0502 and said reference 0506,
(Step 2) a step of accessing said second data block (current destination block) 0503,
(Step 3) a step of accessing said data of changing said reference 0505, and
(Step 4) a step of changing said reference 0506 so as to indicate said third data block (next destination block) 0504, according to said data of changing reference 0505.

### 4.3 Processors System of Synchronization Keeping Reference Consistency

4.3.1 Processors System Expressed as Derived from the Fundamental

A processors system keeping reference consistency is the fundamental processors system,

said data 0150, 0507 contains data expressing plural data blocks, which are
a first data block (source block 0502)
a second data block (current destination block 0503) which is referenced 0506 from said first data block (source block 0502)
a third data block (next destination block 0504) which is to be referenced 0506 from said first data block (source data block 0502) in future
   further
said whole data contains a reference 0506, which is associated with said first data block (source block) 050 indicating said second block (current destination block) 0503
said second editing plan 0123 contains a data 0505 of changing reference indicating said third data block (next destination block) 0504,
   said first process 0105 is further containing

a ninth procedure 0501 configured to perform the following steps,

(Step 1) a step of accessing said first data block (source block) 0502 and said reference 0506,
(Step 2) a step of accessing said second data block (current destination block) 0503,
(Step 3) a step of accessing said data of changing said reference 0505, and
(Step 4) a step of changing said reference 0506 so as to indicate said third data block (next destination block) 0504, according to said data of changing reference 0505.

Said second process 0125 is further containing a tenth procedure 0501 configured to perform the following steps,

(Step 1) a step of accessing said first data block (source block) 0502 and said reference 0506,
(Step 2) a step of accessing said second data block (current destination block) 0503,
(Step 3) a step of accessing said data of changing said reference 0505, and
(Step 4) a step of changing said reference 0506 so as to indicate said third data block (next destination block) 0504, according to said data of changing reference 0505.

### 4.3.2 Processors System Expressed as Independent

The derived processors system can be expressed as an independent processors system, which can be obtained by replacing data 0150 to whole data 0507, by adding phrases shown in the previous section. This is the original claim 15 described in specification of the application 13714422, as follows.

A system comprising:
a first device 0106 which runs a first process 0105 containing:
a first procedure 0107 configured to make a first editing plan 0102 of a first replica 0101 of a whole data 0507, 0150,
   a second device 0126 which runs a second process 0125 containing:
a second procedure 0127 configured to make a second editing plan 0123 of a second replica 0121 of said whole data 0507, 0150,
   wherein
said whole data 0507, 0150 contains data expressing plural data blocks, which are
   a first data block (source block 0502)
   a second data block (current destination block 0503) which is referenced 0506 from said first data block (source block 0502)
   a third data block (next destination block 0504) which is to be referenced 0506 from said first data block (source data block 0502) in future
further
   said whole data contains a reference 0506, which is associated with said first data block (source block) 050 indicating said second block (current destination block) 0503
      said first process 0106 is further containing:
a third procedure 0108 configured to send said first editing plan 0102 to said second process 0126,
a fourth procedure 0109 configured to receive said second editing plan 0123 from said second process 0125,
   said second editing plan 0123 contains a data 0505 of changing reference indicating said third data block (next destination block) 0504,
a fifth procedure 0110 configured to update said first replica 0101, using said first editing plan 0102 and said second editing plan 0123, in order of a sequence 0114 assigned to said first editing plan 0102 and said second editing plan 0123,
a sixth procedure 0501 configured to perform the following steps,
(Step 1) a step of accessing said first data block (source block) 0502 and said reference 0506,
(Step 2) a step of accessing said second data block (current destination block) 0503,
(Step 3) a step of accessing said data of changing said reference 0505, and
(Step 4) a step of changing said reference 0506 so as to indicate said third data block (next destination block) 0504, according to said data of changing reference 0505,
   said second process 0125 is further containing:
a seventh procedure 0128 configured to send said second editing plan 0123 to said first process 0105,
a eighth procedure 0129 configured to receive said first editing plan 0123 from said first process 0105,
an eighth procedure 0130 configured to update said second replica 0121, using said first editing plan 0102 and said second editing plan 0123, in order of said sequence 0114.
a ninth procedure 0501 configured to perform the following steps,
(Step 1) a step of accessing said first data block (source block) 0502 and said reference 0506,
(Step 2) a step of accessing said second data block (current destination block) 0503,
(Step 3) a step of accessing said data of changing said reference 0505, and
(Step 4) a step of changing said reference 0506 so as to indicate said third data block (next destination block) 0504, according to said data of changing reference 0505.

### 5. Synchronization of Edited Data and Edited Definition of Data

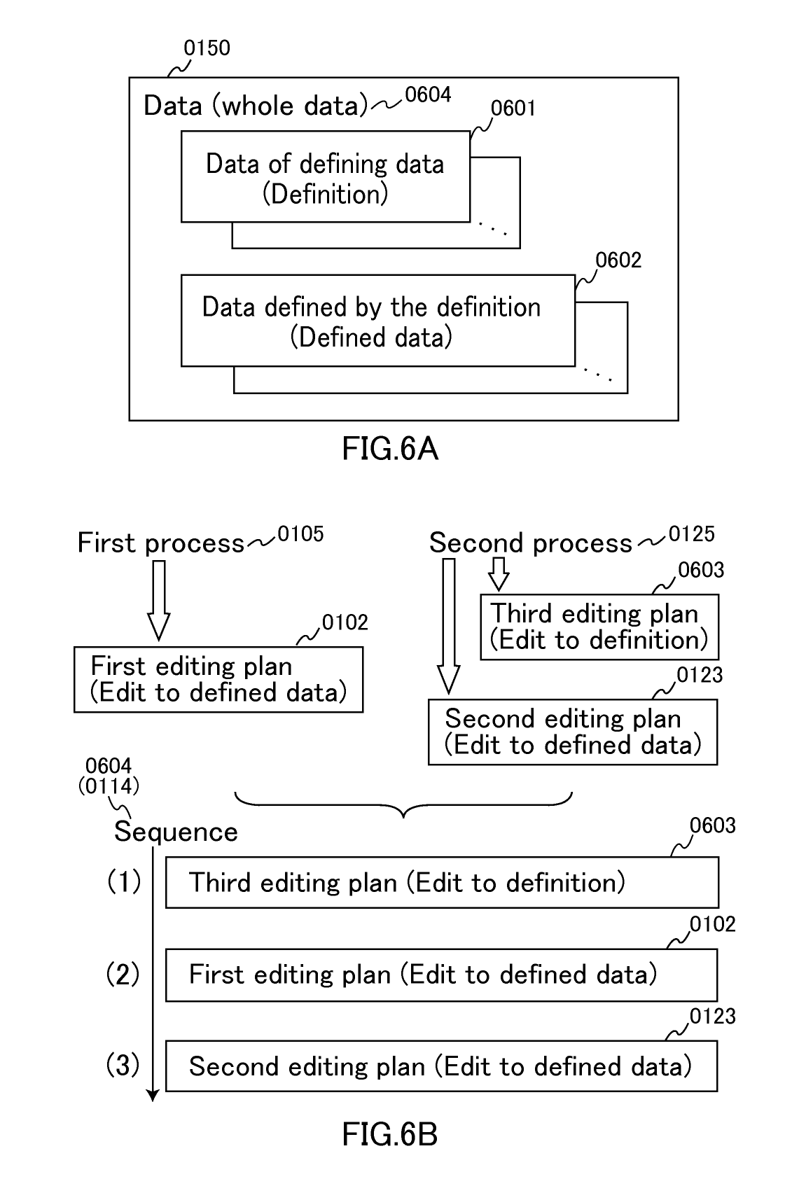

Method and systems, which implement synchronization of edited data and edited definition of data, are described citing FIG. 1, FIG. 6A and FIG. 6B.

A collection of plural data can be a data 0150 of FIG. 1. As shown in FIG. 6A, the data 0150, which is a whole data 0604, can contains a “definition” 0601 and a “defined data” 0602.

The definition 0601 is a data defining structure and/or property of data. Examples of definitions are explained in the next paragraph. The defied data 0602 is a data that has been set according to said definition.

There are many examples of definition and defined data. A class of C++ programming language is a definition (of variables arranged and function) of objects to be created according to the class. The class is a data of defining the objects which are data too. A structure of C programming language is a data of defining (of variables arranged in) memory blocks (which are data too) created by the structure. Programming languages use similar way to define definitions of data.

Database software uses similar way. Definition of data is necessary normally before inputting actual data. Examples of the definitions are a type of the data, acceptable range of the data, reference to another data, and so on.

Suppose that the first editing plan 0102 contains an editing plan of a copy of a defined data 0602, and that the second editing plan 0123 contains an editing plan of another copy of the defined data 0602. The fundamental method synchronizes the first replica 0101 and the second replica 0121 by the first editing plan 0102 and the second plan 0123.

Now, a problem is how to synchronize replicas, when the definition 0601 was edited. Further suppose that the second process 0125 has made a third editing plan 0603 containing an editing plan of the definition 0601, which is a copy in the second replica. Even if the third editing plan 0603 is made first and the second editing plan 0123 is made next by the second process 0125, there are no troubles, because the second process 0125 knows changes of the definition 0601 before the making of the second editing plan 0123. However, the first process 0101, without knowing the third editing plan 060, makes the first editing plan 0102.

Assumed is the following sequence 0604 (0114) of plans, which is (1) the third editing plan 0603, (2) the first editing plan 0102 and (3) the second editing plan 0123. When updating the first replica 0101, the first process 0105 probably finds that (2) of the first editing plan 0102 makes some errors of conflicting to edited definition 0601 by (1) of the third editing plan 0603. The first process 0105 probably rolls back to the situation that is before the updating of (2) of the first editing plan 0102. The first editing plan 0102 probably will be discarded. Next, updating by (3) of the second editing plan 0123 makes no troubles.

Exactly the same situation will be produced at updating of the second replica 0121 by the second process 0125, when the first process 0105 and second process 0125 use same procedures with same sequence of plans. Thus, the replicas synchronize each other.

Editing plan of the definition may be to add definition, to delete the definition or to modify the definition. Adding definition need no modification to the existing defined data 0602. When the definition is deleted, defined data may be deleted. However, actual process of handing these defined data can be specified by application developers. For example, these data may be kept as a part of history data.

When the definition is modified, defined data may be amended in order to adjust modified definition. For example, a mark may be set to defined data not fit for the modified definition. The mark shows to operators, users or other programs that the data is conflicting to the definition. Or, defined data may be changed in order to fit for the modified definition. For example, integer value can be converted to float value.

### 5.1 Method for Synchronization of Edited Data and Edited Definition of Data

5.1.1 Method Expressed as Derived from the Fundamental
A method for synchronization of edited data and edited definition of data is the fundamental method, further
said whole data 0150, 0604 contains a definition 0601 and
a defined data 0602 which has been set according to said definition 0601,
   further
said first editing plan 0102 contains an editing plan of said defined data 0602 of said first replica 0101,
said third procedure is configured to receive a second editing plan and a third editing plan of a second replica 0121 of said whole data 0150, 0604, from said second process,
said second editing plan 0123 contains an editing plan of said defined data 0602 of said second replica 0121, said third editing plan 0603 contains an editing plan of said definition 0601 of said second replica 0121,
said third editing plan 0603 to said second replica 0121 has made by said second process 0125, before or after the making of said second editing plan 0123, and
   further,
said fourth procedure 0110 is configured to update said first replica 0101, using said first editing plan 0102,
said second editing plan 0123 and said third editing plan 0603 in order of a sequence 0114 assigned to said first editing plan 0102, said second editing plan 0123 and said third editing plan 0603, and
said sequence 0114 is used by a fifth procedure 0130 to update said second replica 0121.
   [Note 1] Namely, phrase of “said third editing plan 0603” is added to the third and fourth procedures of the fundamental method.
[Note 2] Said data 0150 may be called whole data 0507, because it contains data expressing plural data blocks.

### 5.1.2 Method Expressed as Independent

The derived method can be expressed as an independent method, which can be obtained by replacing data 0150 to whole data 0507, by adding and replacing phrases shown in the previous section. This is the original claim 16 described in specification of the application 13714422, as follows.

A method, comprising:
a first procedure 0107 to be performed by one of single or plural processor devices 0106 which can handle a first replica 0101 of a whole data 0604, 150,
wherein
said first procedure 0107 is configured to make a first editing plan 0102 of said first replica 0101, and
said first replica 0101 is recorded on a first memory device 0104,
said whole data 0604, 0150 contains a definition 0601 and a defined data 0602 which has been set according to said definition 0601,
   further
said first editing plan 0102 contains an editing plan of
said defined data 0602 of said first replica 0101,
   a second procedure 0108 to be performed by one of said single or plural processor devices 0106, wherein
said second procedure 0108 is configured to send said first editing plan 0102 to a second process 0125,
   a third procedure 0109 to be performed by one of said single or plural processor devices 0106, wherein
said third procedure 0109 is configured to receive a second editing plan 0123 and a third editing plan 0603 of a second replica 0121 of said whole data 0604, 0105, from said second process 0125,
said second editing plan 0123 contains an editing plan of said defined data 0602 of said second replica 0121, said third editing plan 0603 contains an editing plan of said definition 0601 of said second replica 0121,
said third editing plan 0603 has been made by said second process 0125, before or after the making 0127 of said second editing plan 0123, and
   a fourth procedure 0110 to be performed by one of said single or plural processor devices 0106, wherein
said fourth procedure 0110 is configured to update said first replica 0101, using said first editing plan 0102, said second editing plan 0123 and said third editing plan 0603 in order of a sequence 0114 assigned to said first editing plan 0102, said second editing plan 0123 and said third editing plan 0603, and
said sequence 0114 is used by a fifth procedure 0130 to update said second replica 0121.

### 5.2 Memory System for Synchronization of Edited Data and Edited Definition of Data

5.2.1 Memory System Derived from the Fundamental
A memory system for synchronization of edited data and edited definition of data is the fundamental memory system, wherein
said data 0604, 0150 contains a definition 0601 and a defined data 0602 which has been set according to said definition 0601,
   further
said first editing plan 0102 contains an editing plan of said defined data 0602 of said first replica 0102,
said second editing plan 010 contains an editing plan of said defined data 0602 of said second replica 0124,
a third editing plan 0603 to said second replica 0124 is made by said second process 0125, before or after the making of said second editing plan 0123 and
said third editing plan 0603 contains an editing plan of said definition 0601 of said second replica 0121.

### Further,

(Operation: OF) said first replica 0102 is updated by said first editing plan 0102, said second editing plan 0123 and said third editing plan 0603 in order of a sequence 0114 assigned to said first editing plan 0102, said second editing plan 0123 and said third editing plan 0603,
(Operation: OS) said second replica 0121 is updated by said first editing plan 0102, said second editing plan 0123 and said third editing plan 0603 in order of said sequence 0114.

Namely, phrase of “said third editing plan 0603” is added to the fourth procedure of the fundamental processors system.

### 5.2.2 Memory System as Independent

The derived memory system can be expressed as an independent memory system, which can be obtained by replacing data 0150 to whole data 0507, by adding and replacing phrases shown in the previous section. This is the original claim 17 described in specification of the application 13714422, as follows.

A system, comprising:
a first memory device 0104 containing
a first replica 0101 of a whole data 0604, 0150 and
a first editing plan 0102 to said first replica 0101, wherein
said whole data 0604, 0150 contains a definition 0601 and a defined data 0602 which has been set according to said definition,
   further
said first editing plan 0102 contains an editing plan of
said defined data 0602 of said first replica 0101,
   a second memory device 0124 containing
a second replica 0121 of said whole data 0604, 0150 and
a second editing plan 0123 and a third editing plan to said second replica 0121,
said second editing plan 0123 contains an editing plan of said defined data 0602 of said second replica 0121,
said third editing plan 0603 contains an editing plan of said definition 0602 of said second replica 0121,
   further,
said first editing plan 0102 is sent to said second memory device 0124,
said second editing plan 0123 and said third editing plan is sent to said first memory device 0104,
   further,
contents of said first replica 0101 and said second replica 0121 are identical after the following two updating operations:
   operation of updating said first replica 0101 by said first editing plan 0102, said second editing plan 0123 and said third editing plan 0603 in order of a sequence 0114 assigned to said first editing plan 0102, said second editing plan 0123 and said third editing plan 0603, and
   operation of updating said second replica 0121 by said first editing plan 0102, said second editing plan 0123 and said third editing plan 0603 in order of said sequence 0114.

### 5.3 Processors System for Synchronization of Edited Data and Edited Definition of Data

5.3.1 Processor System Expressed as Derived from the Fundamental
A processors system for synchronization of edited data and edited definition of data is the fundamental processors system wherein
said data 0150 contains a data 0601 of definition and a defined data 0602 which has been set according to said definition 0601,
   further
said first editing plan 0102 contains an editing plan of said defined data 0602 of said first replica 0102, said second editing plan 0123 contains an editing plan of said defined data 0602 of said second replica 0124, a third editing plan 0603 to said second replica 0124 is made by said second process 0125, before or after the making of said second editing plan 0123 and said third editing plan 0603 contains an editing plan of said definition 0601 of said second replica 0121.

### Further,

said fifth procedure 0107 is configured to update said first replica 0101, using said first editing plan 0102, said second editing plan 0123 and said third editing plan 0603 in order of a sequence 0114 assigned to said first editing plan 0102, said second editing plan 0123 and said third editing plan 0603,
said eight procedure 0130 configured to update said second replica 0121, using said first editing plan 0102, said second editing plan 0123 and said third editing plan 0603, in order of said sequence 0114.
   Namely, phrase of “said third editing plan 0603” is added to the fourth procedure of the fundamental processors system.

### 5.3.2 Processors System Expressed as Independent

The derived processors system can be expressed as an independent processors system, which can be obtained by replacing data 0150 to whole data 0507, by adding and replacing phrases shown in the previous section. This is the original claim 18 described in specification of the application 13714422. Further, this is the initial claim 2 of this application.

### 6. Synchronization by Version Control

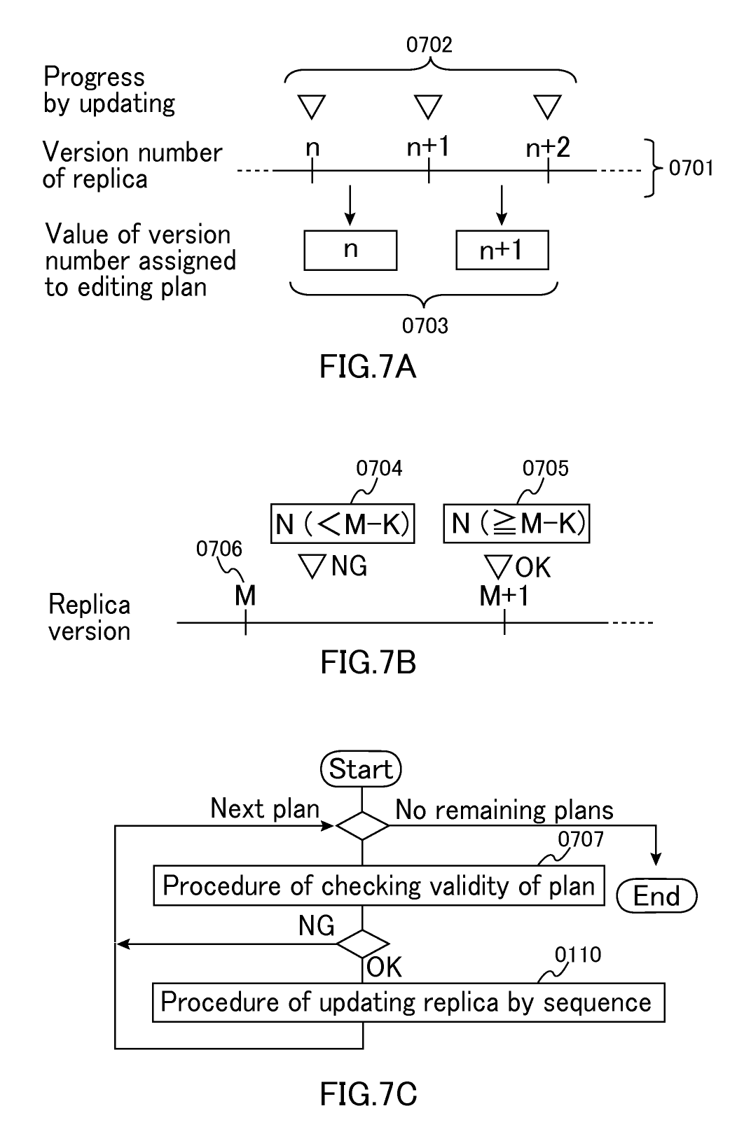

Method and systems, which implement synchronization by version control, are described citing FIG. 1, FIG. 7A, FIG. 7B and FIG. 7C.

It is possible to remove some editing plans before using them for updating replicas by judging validity of each of them. There may be various algorithms to judge validity of editing plans. One way is to use version of replica.

### (1) Replica Version

Replica has been accompanying to an ordinal number 0701 that will be progressed when said first replica is updated 0702 by editing plans. The ordinal number 0701 is called version number of replica. The ordinal number may be integer, character strings which can be used for judging a sequence of values of versions by dictionary style algorithm, or other information which can be used for judging the sequence.

### (2) Version Number Assigned to an Editing Plan

Each editing plan 0703 to the replica is assigned a value of version number of the replica at the time of making the editing plan. This is called “value of assigned version”. Before using the replica to update a replica, the assigned version value is used for checking validity of the replica.

### (3) The First Algorithm of Judging Validity

Assumed that an ordinal number N is the assigned version value to an editing plans 0704, 0705 to a replica. Namely, N was value of version number of the replica at the time of making the plans. Assumed that an ordinal number M is a value of version number of the replica 0706, which is to be updated by the plans. When version number is increased by each updating, N is equal or less than M. Namely N<=M.

Further assumed that an ordinal number K is a pre-determined number. The plan 0704 is judged non-valid, when N is less than M-K. Namely, too old editing plan 0704 is judged non-valid. The plan 0705 is judged valid, when N is equal or greater than M-K (N>=M-K). Namely, not too old editing plan 0705 is judged valid.

### (4) Versions Defined to Portions of Data

Version can be defined to a portion of data 150 whole or the whole data 0507. This version is progressed when this portion is updated by editing plans. The portion can be the whole data 0507, 150 or pre-determined part (or parts) of the whole data 0507, 150.

### (5) Variations

Suitable ordinal number K (the predetermined value K) for each part can be introduced, according to characteristics of each part (of the whole data). If a value K for a part is infinite, all plans for this part are judged valid. Further, we can define appropriate part as the data 150 and can define appropriate K for this part.

### (6) Second Algorithm of Judging Validity

Another algorithm is to compare assigned version value of the first editing plan and assigned version value of second editing plan, if the first editing plan and the second editing plan conflict each other. Plan with later version value may be judged valid. This policy is that plans to latest data should be valid. Opposite policy is that plans to older data can be valid. Selection of them depends on characteristics of data and users policy.

### (7) Third Algorithm of Judging Validity

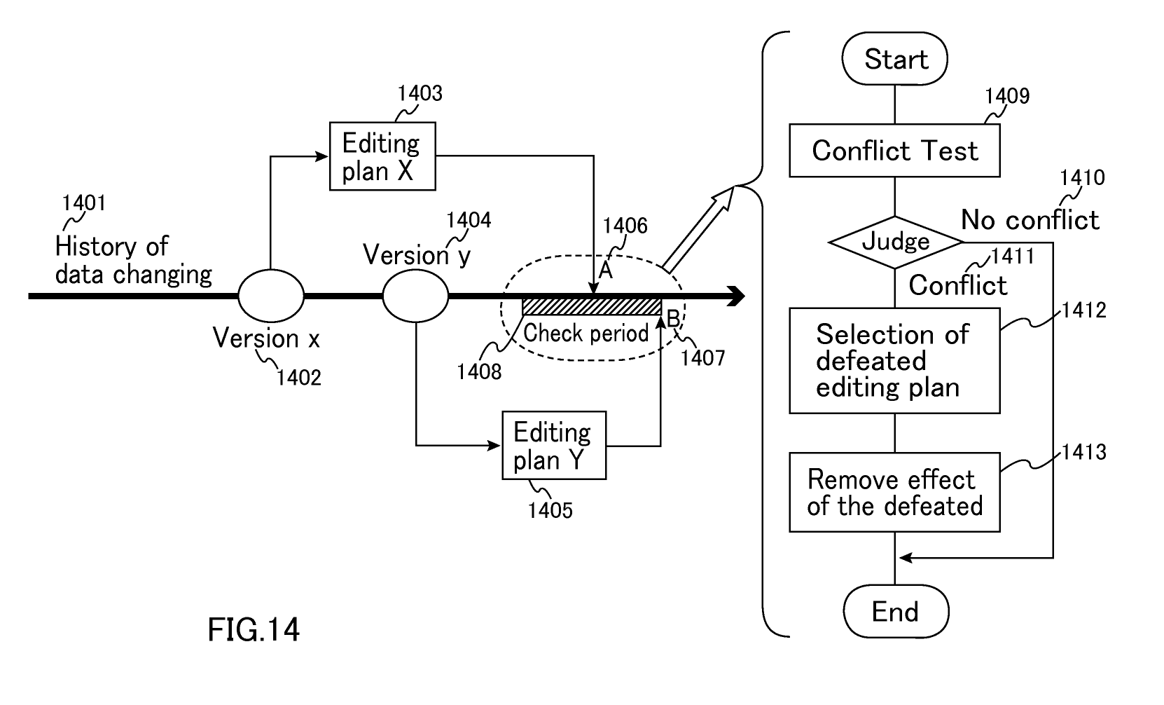

The third algorithm is obtained by modifying of the second algorithm and is described using FIG. 14, as following. Center axis 1041 (from left to right) shows history of changing data 105 (whole data 0507). Editing plan X 1403 was made for replica of version X 1402 and was submitted at time A 1406 for updating data (replica of the data 150, 0507). Editing plan Y 1405 was made to replica of version Y 1404 and was submitted at time B 1407 for updating data (replica of the data 150, 0507). Here, Y is later than X, and B is later than A.

For checking validity of the editing plan Y 1405, checked are editing plans which had been submitted within the pre-determined time period 1408. One simple way to set the predetermined time period 1408 will be set to back from the time B 1407. Thus, editing plan X 1403 is selected for checking validity of the editing work Y 1405.

When there is no conflict 1410 between the editing plan X 1403 and the editing plan Y 1405, there is no reason to judge them to be non-valid. Both of them may be judged valid. When there is a conflict 1411, defeated editing plan will be selected 1412 among them.

If the policy is to judge plan with latest version to be valid, the editing plan X 1403 will be judged non-valid. When the editing plan X 1403 was already used for updating data, the updating will be rolled back. This is removal 1413 of effect by the defeated editing plan X 1403. When the editing plan X 1403 has not been used for updating data, the editing plan X 1403 will be marked not to be used for updating.

### 6.1 Method by Version Control

6.1.1 Method Expressed as Derived from the Fundamental
A method for synchronization by version control is the fundamental method, wherein

said first replica 0101 has been accompanying to a first version number (ordinal number) 0701 progressed 0702 when said first replica is updated,

a value of said first version number (ordinal number) is assigned 0703 to said first editing plan 0102, wherein said value is a value of said first version number (ordinal number) 0701 at the time of making of said first editing plan 0102 (0703),

said second replica 0121 has been accompanying to a second version number (ordinal number) 0701 progressed 0702 when said second replica 0121 is updated,

a value of said second version number (ordinal number) is assigned 0703 to said second editing plan 0123, wherein said value is a value of said second version number (ordinal number) 0701 at the time of making of said second editing plan 0123,

further to said forth procedure

said first editing plan 0102 (0703) is not used for updating said first replica 0101 if said first editorial plan 0102 (0703) is judged non-valid by checking 0707 said value of said first version number (ordinal number) 0701 assigned 0701 to said first editing plan 0102, and

said second plan 0123 (0703) is not used for updating said first replica 0101 if said second editing plan 0123 (0703) is judged non-valid by checking 0707 said value of said second version number (ordinal number) 0701 assigned 0703 to said second plan 0123, and

said first version number (ordinal number) 0701 is progressed 0702 when said first replica 0101 is updated.

### 6.1.2 Method Expressed as Independent

The derived method can be expressed as an independent method, which can be obtained by adding phrases described in the previous section. This is the original claim 19 described in specification of the application 13714422. Further, this is the initial

### 6.2 Memory System by Version Control

6.2.1 Memory System Expressed as Derived from the Fundamental
A memory system for synchronization by version control is the fundamental memory system, wherein

said first replica 0101 has been accompanying to a first version number (ordinal number) 0701 progressed 0702 when said first replica is updated 0110,

a value of said first version number (ordinal number) 0701 is assigned 0703 to said first editing plan 0102, wherein said value is a value of said first version number (ordinal number) 0701 at the time of making of said first editing plan 0102,

said second replica 0121 has been accompanying to a second version number (ordinal number) 0701 progressed 0702 when said second replica 0121 is updated,

a value of said second version number (ordinal number) 0701 is assigned 0703 to said second editing plan 0123, wherein said value is a value of said second version number (ordinal number) 0701 at the time of making of said second editing plan 0123.

Further to (Operation: OF),

said first editing plan 0102 (0703) is not used for updating said first replica 0101 if said first editorial plan 0102 (0703) is judged non-valid by checking 0707 said value of said first version number (ordinal number) 0701 assigned to said first editing plan 0102, and

said second plan 0123 is not used for updating said first replica 0101 if said second editing plan 0123 is judged non-valid by checking 0707 said value of said second version number (ordinal number) 0701 assigned to said second plan 0123, and

said first version number (ordinal number) 0701 is progressed 0702 when said first replica 0101 is updated.

Further to (Operation: OS),

said first editing plan 0102 is not used for updating said second replica 0121 if said first editorial plan 0102 (0703) is judged non-valid by checking 0707 said value of said first version number (ordinal number) 0701 assigned 0703 to said first editing plan 0102, and

said second plan 0123 is not used for updating said second replica 0101 if said second editing plan 0123 (0703) is judged non-valid by checking 0707 said value of said second version number (ordinal number) 0701 assigned 0703 to said second plan 0123, and

said second version number (ordinal number) 0701 is progressed 0702 when said second replica 0121 is updated.

### 6.2.2 Memory System as Independent

The derived memory system can be expressed as an independent memory system, which can be obtained by adding phrases shown in the previous section. This is the original claim 20 described in specification of the application 13714422, as follows.

A system, comprising:
a first memory device 0104 containing
a first replica 0101 of a data 0150 and
a first editing plan 0102 to said first replica 0101, wherein
said first replica 0101 has been accompanying to a first ordinal number 0701 progressed 0702 when said first replica 0101 is updated 0110,
a value of said first ordinal number 0701 is assigned 0703 to said first editing plan 0102, wherein said value is a value of said first ordinal number 0701 at the time of making of said first editing plan 0102, and
   a second memory device 0124 containing
a second replica 0121 of said data 150 and
a second editing plan 0123 to said second replica 0121, said second replica 0121 has been accompanying to a second ordinal number 0701 progressed 0702 when said second replica 0121 is updated 0130,
a value of said second ordinal number 0701 is assigned 0703 to said second editing plan 0123, wherein said value is a value of said second ordinal number 0703 at the time of making of said second editing plan 0123,
   further,
said first editing plan 0102 is sent to said second memory device 0124,
said second editing plan 0124 is sent to said first memory device 0101,
   further,
contents of said first replica 0101 and said second replica 0121 are identical after the following two updating operations:
   (1) operation of updating said first replica 0101 by said first editing plan 0102 and said second editing plan 0123 in order of a sequence 0114 assigned to said first editing plan 0102 and said second editing plan 0123, wherein

said first editing plan 0102 is not used for updating 0110 said first replica 0101 if said first editorial plan 0102 is judged non-valid by checking 0707 said value of said first ordinal number 0701 assigned 0703 to said first editing plan 0102,

said second plan 0123 is not used for updating 0110 said first replica 0101 if said second editing plan 0123 is judged non-valid by checking 0707 said value of said second ordinal number 0701 assigned 0703 to said second plan 0123, and

said first ordinal number 0701 is progressed 0702 when said first replica is updated 0110,

(2) operation of updating 0130 second replica 0121 by said first editing plan 0102 and said second editing plan 0123 in order of said sequence 0114, wherein

said first editing plan 0102 is not used for updating said second replica 0121 if said first editorial plan 0102 is judged non-valid by checking 0707 said value of said first ordinal number 0701 assigned 0703 to said first editing plan 0102,

said second plan 0123 is not used for updating 0130 said second replica 0121 if said second editing plan 0123 is judged non-valid by checking 0707 said value of said second ordinal number 0701 assigned 0703 to said second plan 0123, and

said second ordinal number 0701 is progressed 0702 when said second replica 0121 is updated 0130.

### 6.3 Processors System by Version Control

6.3.1 Processor System Expressed as Derived from the Fundamental
A processors system for synchronization by version control is the fundamental processors system, wherein
said first replica 0101 has been accompanying to a first ordinal number 0701 progressed 0702 when said first replica is updated,
a value of said first ordinal number 0701 is assigned 0703 to said first editing plan 0102 (0703), wherein said value is a value of said first ordinal number 0701 at the time of making of said first editing plan 0102 (0703).
Said second replica 0121 has been accompanying to a second ordinal number 0701 progressed 0702 when said second replica 0121 is updated,
a value of said second ordinal number 0701 is assigned 0703 to said second editing plan 0123, wherein said value is a value of said second ordinal number 0701 at the time of making of said second editing plan 0123.
   Further to said fifth procedure
said first editing plan 0102 (0703) is not used for updating said first replica 0101 if said first editorial plan 0102 (0703) is judged non-valid by checking 0707 said value of said first ordinal number 0701 assigned 0703 to said first editing plan 0102, and
said second plan 0123 (0703) is not used for updating said first replica 0101 if said second editing plan 0123 (0703) is judged non-valid by checking 0707 said value of said second ordinal number 0701 assigned 0703 to said second plan 0123 (0703), and
said first ordinal number 0701 is progressed 0702 when said first replica 0101 is updated.
   Further to said eighth procedure
said first editing plan 0102 (0703) is not used for updating said second replica 0101 if said first editorial plan 0102 (0703) is judged non-valid by checking 0707 said value of said first ordinal number 0701 assigned 0703 to said first editing plan 0102, and
said second plan 0123 (0703) is not used for updating said second replica 0121 if said second editing plan 0123 (0703) is judged non-valid by checking 0707 said value of said second ordinal number 0701 assigned 0703 to said second plan 0123 (0703), and
said second ordinal number 0701 is progressed 0702 when said second replica 0101 is updated.

### 6.3.2 Processors System Expressed as Independent

The derived processor system can be expressed as an independent processors system, which can be obtained by adding phrases shown in the previous section. This is the original claim 21 described in specification of the application 13714422, as follows.

A system comprising:
a first device 0106 which runs a first process 0105 containing:
a first procedure 0107 configured to make a first editing plan 0102 of a first replica 0101 of a data 0150, wherein
said first replica 0101 has been accompanying to a first ordinal number 0701 progressed 0702 when said first replica 0101 is updated 0110,
a value of said first ordinal number 0701 is assigned 0703 to said first editing plan 0102, wherein said value is a value of said first ordinal number at the time of making of said first editing plan 0102,
   a second device 0126 which runs a second process 0125 containing:
a second procedure 0127 configured to make a second editing plan 0123 of a second replica 0121 of said data 0150,
said second replica 0121 has been accompanying to a second ordinal number 0701 progressed 0702 when said second replica 0121 is updated 0130,
a value of said second ordinal number 0701 is assigned 0703 to said second editing plan 0123, wherein said value is a value of said second ordinal number at the time of making of said second editing plan 0123,
   said first process 0106 is further containing:
a third procedure 0108 configured to send said first editing plan 0102 to said second process 0125,
a fourth procedure 0109 configured to receive said second editing plan 0123 from said second process 0125,
a fifth procedure 0110 configured to update said first replica 0101, using said first editing plan 0102 and said second editing plan 0123, in order of a sequence 0114 assigned to said first editing plan 0102 and said second editing plan 0123, wherein
   said first editing plan 0102 is not used for updating said first replica 0101 if said first editorial plan 0102 is judged non-valid by checking 0707 said value of said first ordinal number 0701 assigned 0703 to said first editing plan 0102, and
   said second plan 0123 is not used for updating said first replica 0101 if said second editing plan 0123 is judged non-valid by checking 0707 said value of said second ordinal number 0701 assigned 0703 to said second plan 0123, and
   said first ordinal number 0701 is progressed 0702 when said first replica 0101 is updated 0110,
      said second process 0125 is further containing:
a sixth procedure 0128 configured to send said second editing plan 0123 to said first process 0105,
a seventh procedure 0129 configured to receive said first editing plan 0102 from said first process 0105,
an eighth procedure 0130 configured to update said second replica 0121, using said first editing plan 0102 and said second editing plan 0123, in order of said sequence 0114, wherein
   said first editing plan 0102 is not used for updating 0130 said second replica 0121 if said first editorial plan 0102 is judged non-valid by checking 0707 said value of said first ordinal number 0701 assigned to said first editing plan 0102, and
   said second plan 0123 is not used for updating said second replica 0121 if said second editing plan 0123 is judged non-valid by checking 0707 said value of said second ordinal number 0701 assigned 0703 to said second plan 0123, and
   said second ordinal number 0701 is progressed 0702 when said second replica 0121 is updated 0130.

### 6.4 Derived Claims

### (1) The First Derived Claim

The first derived claim is according to the claims described sections 6.1, 6.2 and 6.3, further

said first editing plan 0102 (0703) is judged non-valid if there is an editing plan conflicting with said first editing plan in pre-determined check period, and

said second plan 0123 (0703) is judged non-valid if there is an editing plan conflicting with said second editing plan in pre-determined check period.

### (2) The Second Derived Claim

The second derived claim is according to the claims described sections 6.1, 6.2 and 6.3, further

said first editing plan 0102 (0703) is judged non-valid if there is an editing plan conflicting with said first editing plan in pre-determined check period, and said value of ordinal number assigned to said first editing plan 0102 (0703) is smaller than an value of ordinal number assigned to said editing plan conflicting with said first editing plan,

said second editing plan 0123 (0703) is judged non-valid if there is an editing plan conflicting with said second editing plan in pre-determined check period, and said value of ordinal number assigned to said second editing plan 0123 (0703) is smaller than an ordinal number assigned to said editing plan conflicting said second editing plan.

### (3) The Third Derived Claim

The third derived claim is according to the claims described sections 6.1, 6.2 and 6.3, further

said first editing plan 0102 (0703) is judged non-valid if there is an editing plan conflicting with said first editing plan, wherein

said value of ordinal number assigned to said first editing plan 0102 (0703) is smaller than an value of ordinal number assigned to said editing plan conflicting with said first editing plan, and

difference between said value of ordinal number assigned to said first editing plan 0102 (0703) and said value of ordinal number assigned to said editing plan conflicting with said first editing plan is smaller than predetermined value,

and further,

said second editing plan 0123 (0703) is judged non-valid if there is an editing plan conflicting with said second editing plan, wherein

said value of ordinal number assigned to said second editing plan 0102 (0703) is smaller than an value of ordinal number assigned to said editing plan conflicting with said second editing plan, and

difference between said value of ordinal number assigned to said second editing plan 0102 (0703) and said value of ordinal number assigned to said editing plan conflicting with said second editing plan is smaller than predetermined value.

### 7. Another Representation of Independent System Claims

### 7.1 Another Memory System Supported by Server Providing Relay Function

The original claim 4 (of section 2.2.2) can be represented by another claim by adding the third memory device. This is the original claim 22 described in specification of the application 13714422, as follows.

A system, comprising:
a first memory device 0104 containing
a first replica 0101 of a data 0150 and
   a second memory device 0124 containing
a second replica 0121 of said data 0150 and
   a third memory device 0201, 0305
   further,
said third memory device 0201, 0305 contains
a first editing plan 0102 to said first replica 0101, and
a second editing plan 0123 to said second replica 0121
   further,
contents of said first replica 0101 and said second replica 0121 are identical after the following two updating operations:
   operation of updating 0110 said first replica 0101 by said first editing plan 0102 and said second editing plan 0123 in order of a sequence 0114 determined by information provided from said third memory device 0201, 0305,
   operation of updating 0130 said second replica 0121 by said first editing plan 0102 and said second editing plan 0123 in order of said sequence 0114.

### 7.2 Other Derived Memory Systems

The original claims 5 and 6 of section 2.4 (4) can be represented by other claims by adding the third memory device. They are the original claims 23 and 24 described in specification of the application 13714422, as follows.

### [The Original Claim 23]

The claim 22, wherein
said sequence 0114 is a sequence of which said first editing plan 0102 and said second editing plan 0123 have arrived to said apparatus 0305, 0201, 0140.

### [The Original Claim 24]

The claim 22, wherein

said sequence 0114 is a sequence of sending said first editing plan 0102 and said second editing plan 0123 from said apparatus 0305, 0201, 0140.

### 7.3 Another Processors System Supported by Server Providing Relay Function

The original claim 7 (of section 2.3.2) can be represented by another claim by adding the third memory device. This is the original claim 25 described in specification of the application 13714422, as follows.

A system comprising:
a first device 0106 which runs a first process 0105 containing:
a first procedure 0107 configured to make a first editing plan 0102 of a first replica 0101 of a data 0150,
   a second device 0126 which runs a second process 0125 containing:
a second procedure 0127 configured to make a second editing plan 0123 of a second replica 0121 of said data 0150,
   a third device 0201, 0305
   said first process 0106 is further containing:
a third procedure 0108 is configured to send said first editing plan 0102 to said third device 0201, 0305, and
a fourth procedure 0109 configured to receive said second editing plan 0123 from said third device 0201, 0305,
a fifth procedure 0110 configured to update said first replica 0101, using said first editing plan 0102 and said second editing plan 0123, in order of a sequence 0114 determined by information from said third device 0201, 0305,
   said second process 0125 is further containing:
a sixth procedure 0128 configured to send said second editing plan 0123 to said third device 0201, 0305,
said seventh procedure 0129 configured to receive said first editing plan 0102 from said third device 0201, 0305,
said eighth procedure 0130 configured to update said second replica 0121, using said first editing plan 0102 and said second editing plan 0123, in order of said sequence 0114.

### 7.4 Other Derived Processors Systems

The original claims 8 and 9 of section 2.4 (4) can be represented by other claims by adding the third memory device. They are the original claims 26 and 27 described in specification of the application 13714422, as follows.

### [The Original Claim 26]

The claim 25, wherein

said sequence 0114 of said fifth procedure 0110 and said eighth procedure 0130 is a sequence of which said first editing plan 0102 and said second editing plan 0123 have arrived to said third device 0305, 0201, 0140.

### [The Original Claim 27]

The claim 25, wherein

said sequence 0114 of said fifth procedure 0110 and said eighth procedure 0130 is a sequence of which said first editing plan 0102 and said second editing plan 0123 have been sent from said third device 0305, 0201, 0140.

### 7.5 Another Memory System Supported by Server Providing Ordinal Numbers

The original claim 11 (of section 3.2.2) can be represented by another claim by adding the third memory device. This is the original claim 28 described in specification of the application 13714422, as follows.

A system, comprising:
A first memory device 0104 containing
a first replica 0101 of a data 0150 and
a first editing plan 0102 to said first replica 0101,
   a second memory device 0124 containing
a second replica 0121 of said data 0150 and
a second editing plan 0123 to said second replica 0121,
   a third device 0401 providing ordinal numbers,
said first editing plan 0102 is assigned a first ordinal number 0402 provided by said third device 0401,
said second editing plan 0123 is assigned a second ordinal number 0403 provided by said third device 0401,
   further,
said first editing plan 0102 is sent to said second memory device 0124,
said second editing plan 0123 is sent to said first memory device 0104,
   further,
contents of said first replica 0101 and said second replica 0121 are identical after the following two updating operations:
   said first replica 0101 is updated 0110 by said first editing plan 0102 and said second editing plan 0123 in order of a sequence 0114, 0404 determined by said first ordinal number 0402 and said second ordinal number 0403, said second replica 0121 is updated by said first editing plan 0102 and said second editing plan 0123 in order of said sequence 0114, 0404.

### 7.4 Another Processors System Supported by Server Providing Ordinal Numbers

The original claim 11 (of section 3.3.2) can be represented by another claim by adding the third memory device. This is the original claim 29 described in specification of the application 13714422, as follows.

A system comprising:
a first device 0106 which runs a first process 0105 containing:
a first procedure 0107 configured to make a first editing plan 0102 of a first replica 001 of a data 0150,
   a second device 0124 which runs a second process 0125 containing:
a fourth procedure 0127 configured to make a second editing plan 0123 of a second replica 021 of said data 0150,
   a third device 0401 providing ordinal numbers 0402, 0403, said first process 0105 further containing:
a second procedure 0405 configured to receive a first ordinal number 0402 provided by said third device 0401,
a third procedure 0406 configured to assign said first ordinal number 0401 to said first editing plan 0102,
a seventh procedure 0108 configured to send said first editing plan 0102 to said second process 0125,
an eighth procedure 0109 configured to receive said second editing plan 0123 from said second process 0125,
a ninth procedure 0110 configured to update said first replica 0101, using said first editing plan 0102 and said second editing plan 0123, in order of a sequence 0114, 0404 determined by said first ordinal number 0402 and said second ordinal number 0403,
   said second process 0125 further containing:
a fifth procedure 0405 configured to receive a second ordinal number 0403 provided by said third device 0401,
a sixth procedure 0406 configured to assign said second ordinal number 0403 to said second editing plan 0123,
a tenth procedure 0128 configured to send said second editing plan 0123 to said first process 0105,
an eleventh procedure 0129 configured to receive said first editing plan 0102 from said first process 0105,
a twelfth procedure 0130 configured to update said second replica 0121, using said first editing plan 0102 and said second editing plan 0123, in order of said sequence 0114, 0404.

### 8. Example One

In this section, data 0505 of changing reference indicating said next destination block 0504 is called Information Changing Reference (ICR). After plans containing ICRs are used for updating replicas 0101, 0124, ICRs are set to replicas.

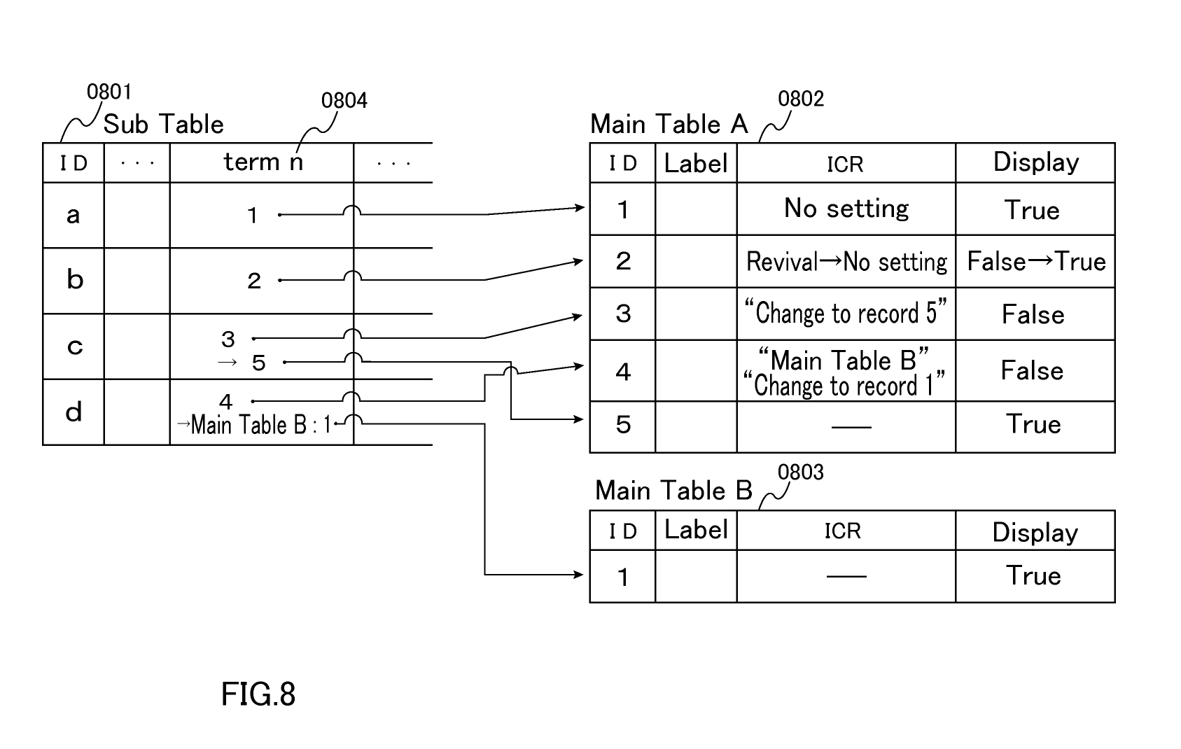

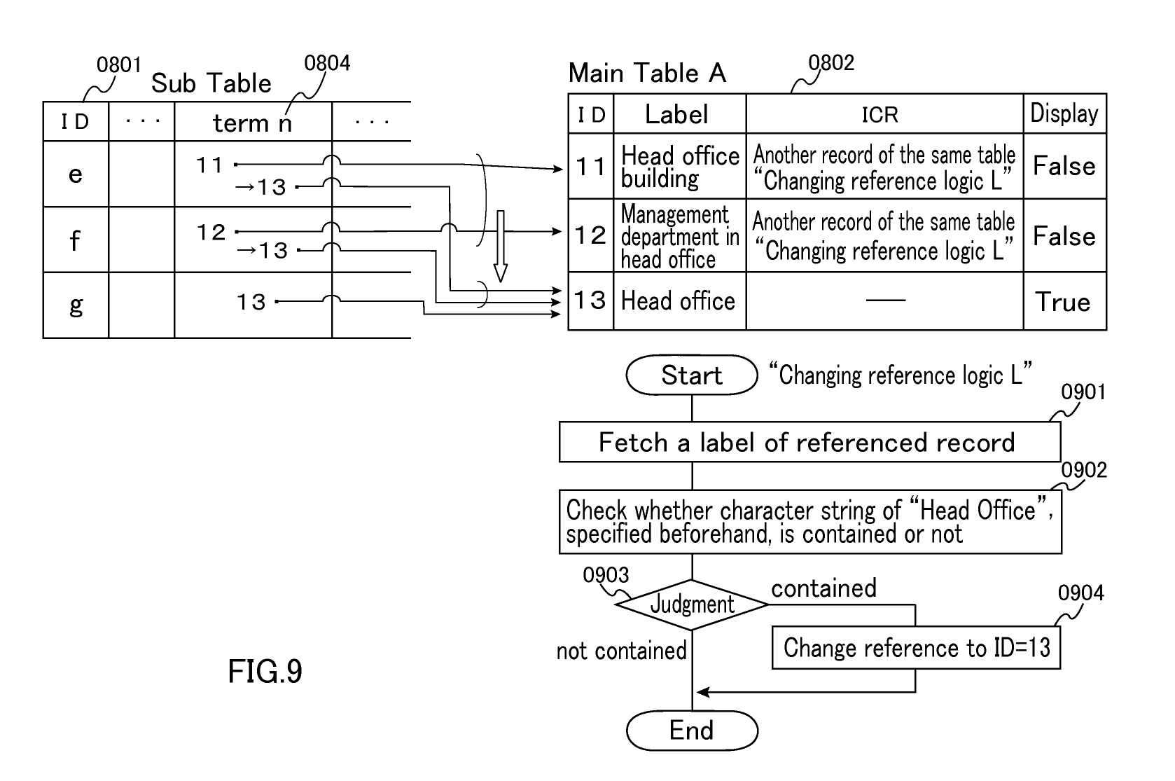

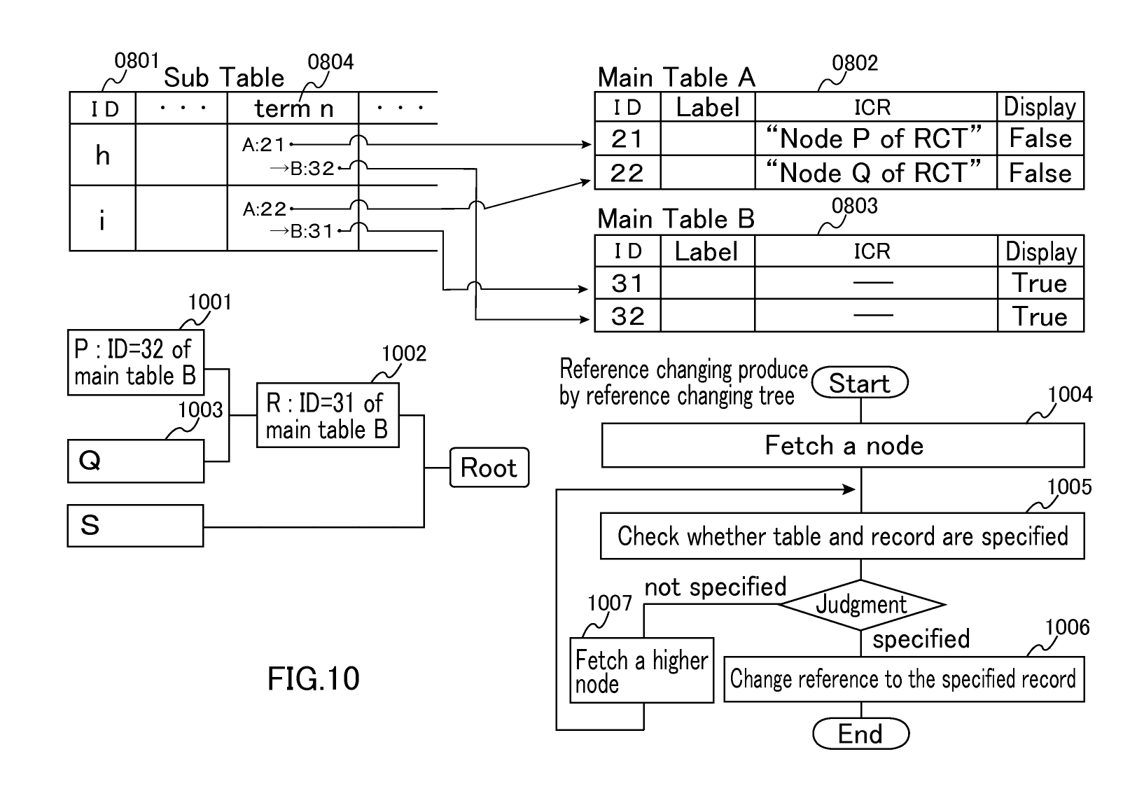

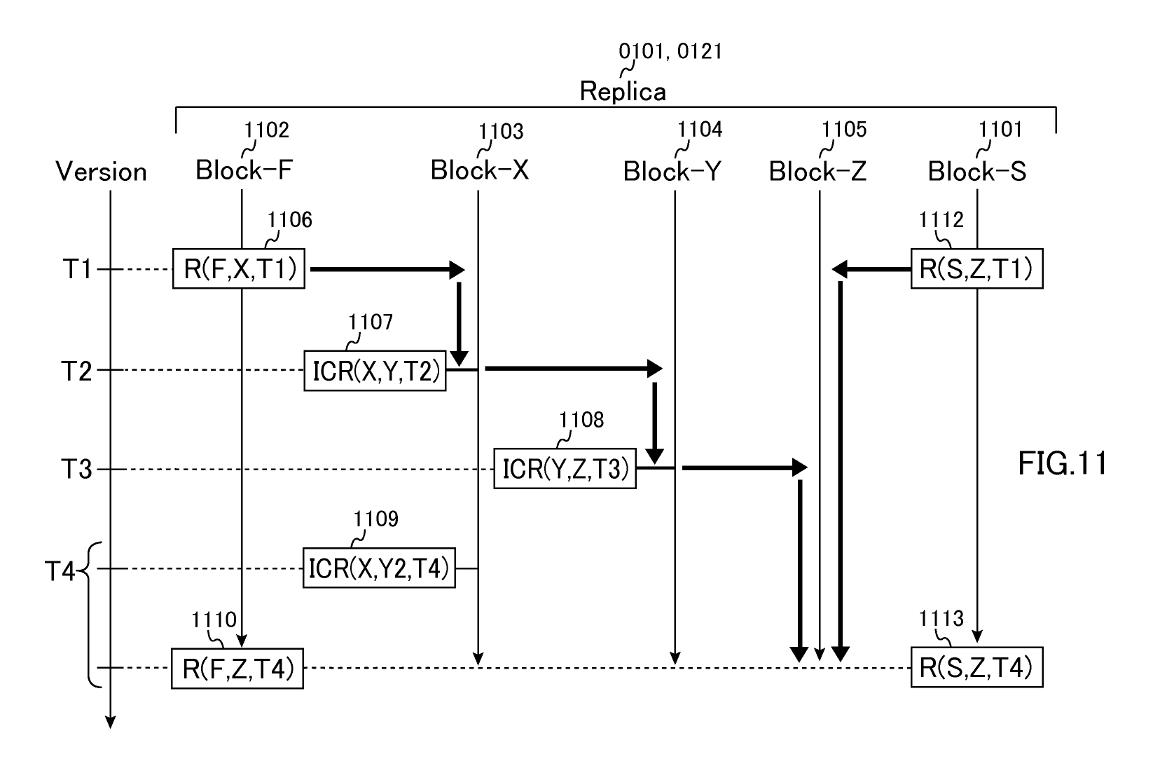

This example is described citing FIG. 1, FIG. 8, FIG. 9 and FIG. 10. For explaining multiple changes of references of Section 8.5, FIG. 11 is cited.

### 8.1 Simple Mechanism of Changing Reference

In FIG. 8, ICRs have been registered to referenced records. Term n 0804 of record “ID=c” in sub table 0801 refers record “ID=3” of main table A 0809. ICR registered to this record is “Change to record 5”. In this figure, ICR is shown as a value of the third term of main table A 0809. As another implementation, it is possible to use supplementary table to show mapping of referenced records and ICRs by one of popular dictionary mechanisms.

When term n 0804 of record “ID=c” in sub table 0801 is accessed, referenced record “ID=3” of main table A 0809 will be accessed. And, ICR registered to this record is accessed. Reference from term n 0804 of record “ID=c” of sub table 0801 will be changed to record “ID=5” of main table A 0809, according to the ICR of “Change to record 5”.

8.2 Changing References into Another Table

When term n 0804 of record “ID=d” in sub table 0801 is accessed, referenced record “ID=4” of main table A 0809 is also accessed. At this time, ICR registered to this record is accessed. And reference from record “ID=d” in sub table 0801 is changed to record “ID=1” of main table B 0810, according to the ICR of Main table B″ and “Change to record 1”. If there is only one DB to be treated, typical ICR can be consisting of “Table S” (S is sample table name for explanation)+“Record Y” (Y is sample ID: major key for explanation). This indicates to change reference to record Y in table S.

### 8.3 Preventing Circulation of Changing Reference in a Table

If there are many changing at table A 0809, infinite circulations of changing may occur. It can be prevented by using changing reference to another table. Beside main table A 0809, new main table such as table B 0810 is introduced. If all ICRs of table A indicate changing reference to records of table B as shown for record “ID=4” of main table A 0809, there will be no circulation of reference changing. For concise explanation by FIG. 8, term n 0804 of sub table 0804 refers records of main table A 0809 and main table B 0810. However, most of current DBs embodiments employ restriction that only one main table is referred by one term (column) of a sub table. It is practical to introduce a restriction that one term (column) of table refers only new main table for usual Operation: OS, and the former main table should only be accessed by a program base on the present invention for changing a reference.

### 8.4 Variations

### (1) No Changing

When term n 0804 of record “ID=a” in sub table 0801 is accessed, referenced record “ID=1” of main table A 0809 is also accessed. There will be no change of reference from record “ID=a”, because ICR is not registered to this record or ICR of “no setting” is registered.

### (2) Revival of Record

In FIG. 8, “display=False” is a mark showing deleted status of this record. If a record is not displayed on a screen, or not to be accessed by user programs, it is equal to be deleted for them. In main table A 0809, records with ID=2, 3, and 4 are in deleted status (display=False). When accessing a record “ID=b” of sub table 0801, “display=True” is set for record ID=2 of main table A 0809, because “Revival” is detected while checking the ICR. After revival work is done, ICR of “revival” is changed to “no setting.”

### (3) Changing Reference Logic

When ICR is “another record of the same table”+“changing reference logic L” (L is a sample label of logic for explanation), or when ICR is “record of another table”+“changing reference logic L”, procedure of changing reference is explained as follow. Here “logic” means process to get new referenced record. When this record of the main table is referred from a sub table, logic specified by L is invoked. Result of logic L shows a new referenced record. At the initial, record “ID=e” of a sub table 0801 of FIG. 9 refers to the record “ID=11” of main table A 0809. ICR of this record is “Another record of the same table” and “Changing reference logic L”. Thus logic L is invoked.

FIG. 9 shows a sample implementation of logic Las follows. First, fetch 0901 a label of the originally referenced record, that is “Head office building” in this example. Next, check 0902 whether label of the fetched label contains character string, specified beforehand, for example the “Head office”, or not. If contained 0910, change 0904 reference of record with ID=e of sub table 0801 into reference to record of ID=13 of main table A 0809 that is specified beforehand. Record of ID=f of sub table 0801 is referring to record of ID=12 of main table A 0809 at the initial. Similarly, this reference will be changed to record of ID=13 of main table A 0809. Thus, all references to records of different expressions such as “Head office building”, “Management department in head office” and “Head office” of same concept, are unified to references to a record of “Head Office”.

Another implementation of logic L is logic to get ID of new table that is exactly same with ID of the old table. This logic is useful to convert a reference to old table to a new table with more records added to the tail of table. Another implementation of logic L is logic to get old ID+fixed value. This logic is useful to convert a reference to old table to a new table with more records added to the head of table.

### (4) Tree for Changing Reference

Tree for changing reference (TCR) is a tree structured information of changing reference, When ICR is “Node V of a TCR” (V is explanatory label of node), reference will be changed to a record specified by node V. If no record is specified with node V, search higher nodes of V in order, detect the first node with record, and use it as new referenced record.

At the beginning, term n 0804 of record “ID=h” of sub table 0804 of FIG. 10 refers to the record with “ID=21” of main table A 0809. ICR of this record is “Node P of ICR”. And, fetch 1004 node P 1008 and check 1005 whether table and record are specified at this node or not. Since “ID=32 of main table B” is specified, change 1006 the reference to the specified record.

At the beginning, term n 0804 of record “ID=i” of sub table 0801 refers to record “ID=22” of main table A 0809. ICR of this record is “node Q of TCR”. And, fetch 1004 node Q 1003 and check 1005 whether table and record are specified at this node or not. Since node Q has no information, fetch 1007 higher node, that is node R 1009, and check 1005 whether table and record are specified at this node or not. Since there is “ID=31 of main table B”, change 1006 the reference to the specified record.

It is good idea not to show records with ICRs to operators or user programs, for avoiding setting new reference to them. Only program for manipulating ICR and changing reference will access them. In FIG. 10, main table A 0802 is not displayed but only main table B 0803 that is the new main table will be displayed. Therefore, an operator cannot choose a record of main table A as a reference destination. In FIG. 9, records with ID=11 and 12 are not displayed (display=False) but only a record with ID=13 is displayed. That is, only “Head office” can be set as new reference destination. Records with ICR or property “Display=False” will be shown only for operators who manipulate them, of course.

### 8.5 Multiple Changes of References

For explaining multiple changes of references, FIG. 11 is cited.

### (1) Version

Section 6 introduced version of replica and assigned version to editing plan. Reference and ICR can be linked to the version.

R(F, X, T) is a reference 0506, which indicates:
F is source block 0502.
X is current destination block 0503.
T is a value (of version of a replica) of the time X has been confirmed as the right destination.
ICR (X, Y, T) is information of changing reference, which indicates:
X is a block 0503, which the ICR 0505 is assigned to.
Y is a next destination block 0504,
T is a value (of version of a replica) of the time ICR has been created.

### (2) Initial State

After updating of replicas 0104, 0124 by plans, ICRs contained in the plans are set to replicas. By this way, ICRs 1107, 1108, 1109 have been set in FIG. 11

### (3) Updating of Reference, Simple Case

Suppose that the current version of the replica is T4, and a reference from block-S 1101, R(S,Z,T1) 1112, is accessed. Because block-Z has been assigned no ICR, the reference is not changed. Because the reference has been confirmed at T4, R(S,Z,T1) 1112 is updated to R(S,Z,T4) 1113. Though R(S,Z,T1) 1112 and R(S,Z,T4) 1113 are placed in different positions in FIG. 11, only T1 is rewritten to T4.

### (4) Updating of Reference, Complicated Case

Suppose that the current version of the replica is T4, and a reference from block-F, R(F,X,T1) 1106, is accessed. By accessing the current destination block-X, ICR(X, Y, T2) is found. ICR(X, Y, T2) is set to block-X at T2, which is later than T1. Further no ICR is set between T1 and T2.

Block-Y is accessed according to ICR (X, Y, T2), and ICR (Y, Z, T3) is found. ICR(Y, Z, T3) is set to block-Y at T3, which is later than T2. Further no ICR is set between T2 and T3.

Finally, block-Z is accessed. Because block-Z has no ICR (of later than T3), the reference is changed to block-Z. Thus, R(F,X,T1) 1106 is updated to R(R,Z,T4) 1110. Though R(F,X,T1) 1106 and R(R,Z,T4) 1110 are placed in different positions in FIG. 11, only X and T1 are rewritten to Z and T4. T4 of R(R,Z,T4) indicates the reference has been confirmed at T4.

### 9. Example Two

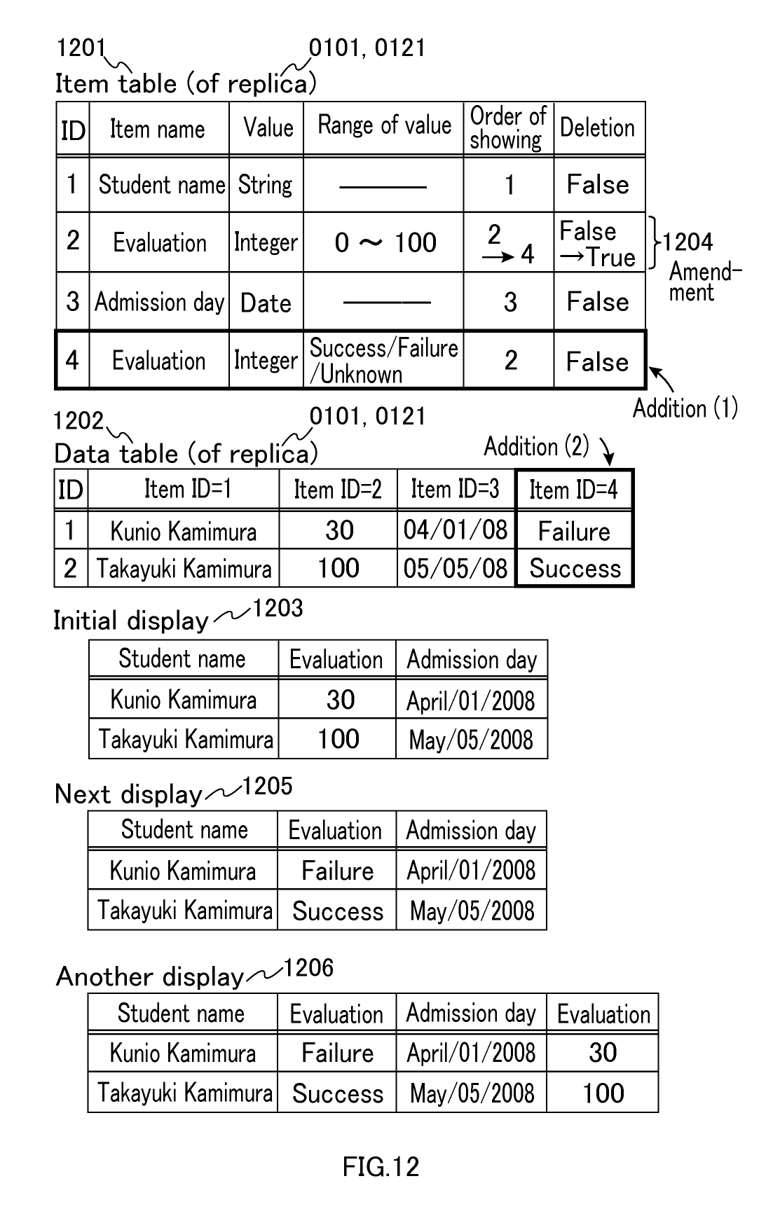

This example is described citing FIG. 1 and FIG. 12.

The whole data 0105, 0604 can contain item table 1201 and data table 1202. Each record of item table 1201 defines each item of data table 1202. The first replica 0101 and the second replica 0121 contain copy of item table 1201 and data table 1202, too. These copies of item table 1201 and data table 1202 are called “item table” 1201 and “data table” 1202, for simplifying the discussion.

### (1) Initial State

Initial table has three records (ID=1, 2, 3). The first record (ID=1, “Student name”) defines the first item of the data table 1202. The second record (ID=2, “Evaluation”) defines the second item of the data table 1202. The third record (ID=3, “Admission day”) defines the third item of the data table 1202. The data table 1202 has two records (ID=1, 2).

### (2) Initial Display to Operator

The initial display to an operator is shown by the third table 1203.

### (3) Editing Plan

As an example, an editing plan contains the following action plans.

### (Action One)

The fourth record (ID=4, “Evaluation”) is added to the item table 1201. This is addition (1).

### (Action Two)

The second record (ID=2) of the item table 1201 is amended 1204, as follows. Ordering of showing is changed into 4. Deletion flag is changed to “True”.

### (Action Three)

Data table 1202 is reformed according to the amended item table 1201.

### (Action Four)

Each value of newly added item (Item ID=4) of each existing record is set by applying the following criteria. If the old evaluation (Item ID=2) is less than 60 and greater than zero, the new evaluation (Item ID=4) is set to “Failure”. If the old evaluation (Item ID=2) is equal or greater than 60 and equal or less than 100, the new evaluation (Item ID=4) is set to “Success”. For other cases, the new evaluation (Item ID=4) is set to “Unknown”.

### (4) Updating Replicas

After updating replicas by the editing plan, item table 1201 has four records and data table 1202 has four items, as shown by the top two tables of FIG. 12.

### (5) Next Display to Operator

In order to display the data table 1202, records of the item table 1201 are checked. Because deletion flag is “True”, the old evaluation (Item ID=2) column of data table is not shown. Because ordering of showing is 2, the new evaluation (Item ID=4) column is shown as the second column.

Probably, the operator recognizes that numerical evaluations have been changed to Success/Failure status, as shown by the fourth table 1205 of FIG. 12.

### (6) Revival of Numerical Evaluation

Assumed that another plan is to set the deletion flag of the second record (ID=2) of the item table 1201 to “False”. After this plan was used for updating replicas, the displayed table to the operator has the fourth column showing the numerical evaluations, which was the former second column. This is the fifth table 1206 of FIG. 12.

### 10. Example Three

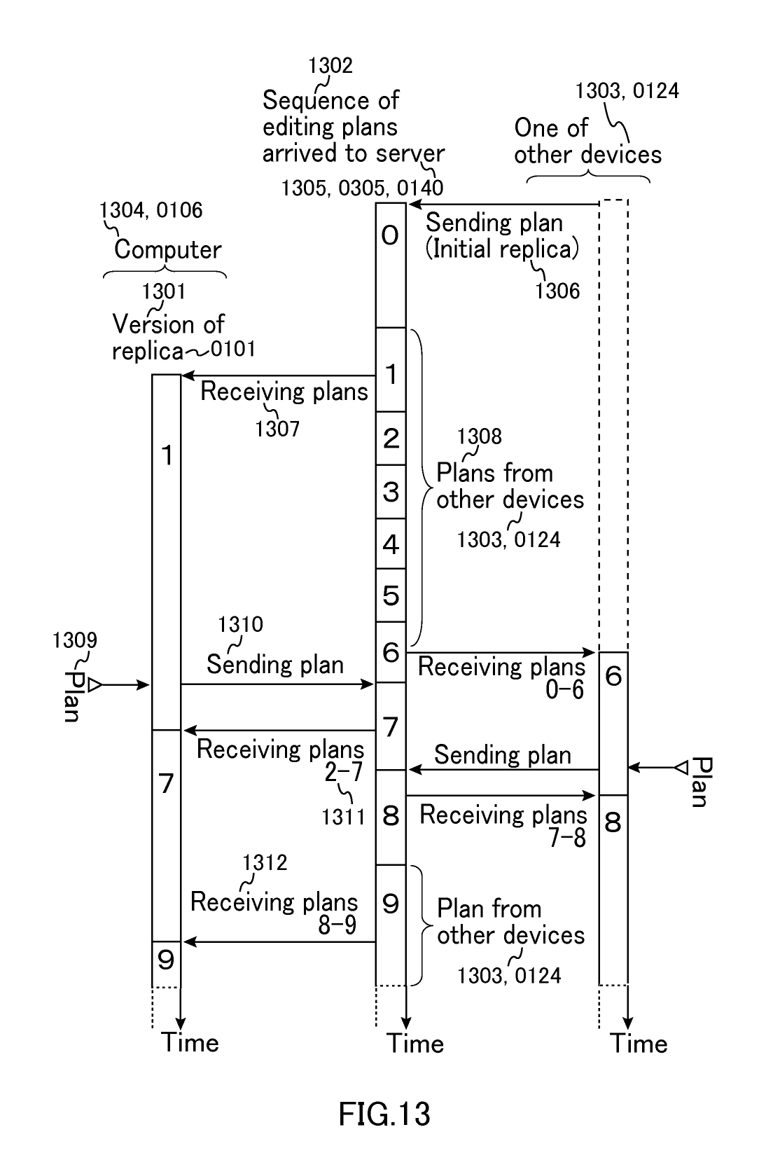

This example is described citing FIG. 1 and FIG. 13.

FIG. 13 shows an example of history of changing version 1301 of replica 0101 contained in a computer 1304, 0106.

At first, the computer 1304, 0106 receives 1306 editing plan-0 and plan-1. The editing plan 0 was sent 1306 from one of other devices 1303, 0124, and is an initial replica of the history. Editing plan-1 was sent 1303, 0124 from one of other devices.

After updating empty replica 0101 by the editing plan-0 and plan-1, version of the replica shall be 1. Editing plans-2, 3, 4, 5, 6 were sent 1308 from other devices.

When a plan is made 1309 by the computer 1304, 0106, the plan is immediately sent 1310 and is lined to the sequence as plan-7. Next, the computer 1304, 0106 receives 1312 plans-2, 3, 4, 5, 6 and 7. After updating the replica by these editing plans, version of the replica shall be 7.

I claim:

1. A method, comprising:
a first procedure to be performed by one of single or plural processor devices which can handle a first replica of a whole data, wherein
said first procedure is configured to make a first editing plan of said first replica, and
said first replica is recorded on a first memory device,
further
said whole data contains data expressing plural data blocks, which are
a first data block,
a second data block which is referenced from said first data block, and
a third data block which is to be referenced from said first data block in future,
further
said whole data contains a reference, which is associated with said first data block indicating said second block,
said second editing plan contains a data of changing reference indicating said third data block,
a second procedure to be performed by one of said single or plural processor devices, wherein
said second procedure is configured to send said first editing plan to a second process,
a third procedure to be performed by one of said single or plural processor devices, wherein
said third procedure is configured to receive a second editing plan of a second replica of said whole data, from said second process,
said second editing plan contains a data of changing reference indicating said third data block,
a fourth procedure to be performed by one of said single or plural processor devices, wherein
said fourth procedure is configured to update said first replica, using said first editing plan and said second editing plan in order of a sequence assigned to said first editing plan and said second editing plan, and
said sequence is used by a fifth procedure to update said second replica,
a fifth procedure to be performed by one of said single or plural processor devices, wherein
said fifth procedure configured to perform the following steps,
(Step 1) a step of accessing said first data block and said reference,
(Step 2) a step of accessing said second data block,
(Step 3) a step of accessing said data of changing said reference, and
(Step 4) a step of changing said reference so as to indicate said third data block, according to said data of changing reference 0505.

2. A system comprising:
a first device which runs a first process containing:
a first procedure configured to make a first editing plan of a first replica of a whole data, wherein
said whole data contains a definition and a defined data
which has been set according to said definition,
further
said first editing plan contains an editing plan of said defined data 0602 of said first replica,
a third editing plan to said second replica is made by said second process, before or after the making of said second editing plan and
said third editing plan contains an editing plan of said definition of said second replica,
a second device which runs a second process containing:
a second procedure configured to make a second editing plan and a third editing plan of a second replica of said whole data,
said second editing plan contains an editing plan of said defined data 0602 of said second replica,
said third editing plan contains an editing plan of said definition of said second replica,
said first process is further containing:
a third procedure configured to send said first editing plan to said second process,
a fourth procedure configured to receive said second editing plan and said third editing plan from said second process,
said fifth procedure is configured to update said first replica, using said first editing plan, said second editing plan and said third editing plan in order of a sequence assigned to said first editing plan, said second editing plan and said third editing plan,
said second process is further containing:
a sixth procedure configured to send said second editing plan and said third editing plan to said first process, a seventh procedure configured to receive said first editing plan from said first process,
said eight procedure configured to update said second replica, using said first editing plan, said second editing plan and said third editing plan, in order of said sequence.

3. A method, comprising:
a first procedure to be performed by one of single or plural processor devices which can handle a first replica of a data, wherein
said first procedure is configured to make a first editing plan of said first replica, and
said first replica is recorded on a first memory device, wherein
said first replica has been accompanying to a first ordinal number progressed when said first replica is updated,
a value of said first ordinal number is assigned to said first editing plan, wherein said value is a value of said first ordinal number at the time of making of said first editing plan,
a second procedure to be performed by one of said single or plural processor devices, wherein
said second procedure is configured to send said first editing plan to a second process,
a third procedure to be performed by one of said single or plural processor devices, wherein
said third procedure is configured to receive a second editing plan of a second replica of said data, from said second process,
said second replica has been accompanying to a second ordinal number progressed when said second replica is updated.
a value of said second ordinal number is assigned to said second editing plan, wherein said value is a value of said second ordinal number at the time of making of said second editing plan,
a fourth procedure to be performed by one of said single or plural processor devices, wherein
said fourth procedure is configured to update said first replica, using said first editing plan and said second editing plan in order of a sequence assigned to said first editing plan and said second editing plan, and
said sequence is used by a fifth procedure to update said second replica,
further
said first editing plan is not used for updating said first replica if said first editorial plan is judged non-valid by checking said value of said first ordinal number assigned to said first editing plan, and
said second plan is not used for updating said first replica if said second editing plan is judged non-valid by checking said value of said second ordinal number assigned to said second plan, and
said first ordinal number is progressed when said first replica is updated.

4. The method of claim 3, further:
said first editing plan is judged non-valid if there is an editing plan conflicting with said first editing plan in pre-determined check period, and said value of ordinal number assigned to said first editing plan is smaller than an value of ordinal number assigned to said editing plan conflicting with said first editing plan.

5. The method of claim 3, further:
said first editing plan is judged non-valid if there is an editing plan conflicting with said first editing plan, wherein
said value of ordinal number assigned to said first editing plan is smaller than an value of ordinal number assigned to said editing plan conflicting with said first editing plan, and
difference between said value of ordinal number assigned to said first editing plan and said value of ordinal number assigned to said editing plan conflicting with said first editing plan is smaller than predetermined value.
